(19) United States
(12) Patent Application Publication
(10) Pub. No.: US 2017/0262868 A1
(43) Pub. Date: Sep. 14, 2017

(54) METHODS AND SYSTEMS FOR ANALYZING CUSTOMER CARE DATA

(71) Applicant: XEROX CORPORATION, Norwalk, CT (US)

(72) Inventors: Geetha Manjunath, Bangalore (IN); Avinash Sharma, Bangalore (IN); Narayanan Unny Edakunni, Bangalore (IN); Divanshu Gupta, Bangalore (IN); Manoj Gupta, Bangalore (IN); Shruti Kunde, Mumbai (IN); Rong Zhou, San Jose, CA (US)

(21) Appl. No.: 15/064,642

(22) Filed: Mar. 9, 2016

(51) Int. Cl. G06Q 30/02; G06F 17/30; G06Q 30/00

(52) U.S. Cl. CPC G06Q 30/0201; G06Q 30/016; G06F 17/30979; G06F 17/30997; G06F 17/30932; G06F 17/30684; G06F 17/30958; G06F 17/30991

(57) ABSTRACT

A method and a system are provided to derive one or more observations between a plurality of parameters in customer care data. The method includes receiving customer care data from a plurality of data sources. Thereafter the customer care data is transformed to create a plurality of data structures utilizing one or more semantic web protocols. The plurality of data structures represents a relationship between one or more parameters in the customer care data. Thereafter a subset of data structures is extracted from the plurality of data structures based on a query received via a query interface. One or more graph analytics techniques are applied on the subset of data structures to determine one or more observations associated with the subset of data structures. Thereafter the one or more observations pertaining to the subset of data structures are displayed on a display screen.

### TECHNICAL FIELD

The presently disclosed embodiments are related, in general, to customer care systems. More particularly, the presently disclosed embodiments are related to methods and systems for deriving one or more observations between a plurality of parameters associated with a plurality of customers in a customer care data.

### BACKGROUND

Customer care data may be obtained from a plurality of data sources. In an embodiment, the customer care data refers to a voluminous amount of structured, semi-structured, and unstructured data obtained from the plurality of data sources that has to be mined for deriving one or more observations. Usually, the customer care data is characterized based on four attributes namely volume, variety, velocity, and veracity. The customer care data usually comprises measurements of large numbers of variables that have been observed at multiple instances. Since, the observations at multiple instances may be dependent on various factors; therefore, usually the observations can have large variability that makes analysis difficult.

In some scenarios, determining inherent relationships among data variables may be required for drawing out real time or near real time observations. However, determining inherent relationships in the customer care data may be difficult, due to the four attributes discussed above. Additionally, deriving one or more observations between a plurality of parameters associated with a plurality of customers in the customer care data may not be a trivial task because of the inherent relationships in the customer care data.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for deriving one or more observations between a plurality of parameters associated with a plurality of customers in a customer care data. The method utilizes one or more processors to receive the customer care data from a plurality of data sources. In an embodiment, the customer care data received from the plurality of data sources may comprise a plurality of problems faced by a customer from the plurality of customers while operating a product, wherein the plurality of problems corresponds to the plurality of parameters. The method transforms the customer care data to create a plurality of data structures utilizing one or more semantic web protocols. In an embodiment, the plurality of data structures may represent a relationship between the plurality of parameters associated with the plurality of customers in the customer care data. The method further extracts a subset of data structures from the plurality of data structures based on a query received via a query interface. In an embodiment, the query may comprise prediction of one or more problems from the plurality of problems, wherein the one or more problems comprises the plurality of problems occurring more than a pre-defined number of times. In an embodiment, the one or more problems are predicted before receiving a communication from the customer. Further, the method applies one or more graph analytics techniques on the subset of data structures to determine one or more observations associated with the subset of data structures. In an embodiment, the one or more observations may correspond to the one or more problems occurring more than the pre-defined number of times. Further the method may transmit a notification comprising the one or more observations pertaining to the query, to a user-computing device associated with a customer care agent who will receive the communication from the customer via a communication network, wherein the notification is transmitted before receiving the communication from the customer.

According to embodiments illustrated herein, there is provided a system that comprises of an application server configured to derive one or more observations between a plurality of parameters associated with a plurality of customers in a customer care data. The application server further comprises of one or more processors wherein the application server is connected to a user computing device associated with a customer care agent via a communication network. In an embodiment, the one or more processors of the application server may be configured to receive the customer care data from a plurality of data sources. The one or more processors may be further configured to transform the customer care data to create a plurality of data structures utilizing one or more semantic web protocols, wherein the plurality of data structures may represent a relationship between the plurality of parameters in the customer care data. The one or more processors may further extract a subset of data structures from the plurality of data structures based on a query received via a query interface. The one or more processors may further apply one or more graph analytics techniques on the subset of data structures to determine one or more observations associated with the subset of data structures. The one or more processors may further display the one or more observations, on a display screen, pertaining to the query based on the one or more graph analytics techniques.

According to embodiments illustrated herein, a non-transitory computer-readable storage medium having stored thereon, a set of computer-executable instructions for causing a computer comprising one or more processors to perform steps of receiving, by one or more processors, customer care data from a plurality of data sources, wherein the customer care data received from the plurality of data sources comprises a plurality of problems faced by a customer from a plurality of customers while operating a product, wherein the plurality of problems corresponds to a plurality of parameters. The one or more processors may transform the customer care data to create a plurality of data structures utilizing one or more semantic web protocols, wherein the plurality of data structures represents a relationship between the plurality of parameters associated with the plurality of customers in the customer care data. The one or more processors may extract a subset of data structures from the plurality of data structures based on a query received via a query interface, wherein the query comprises predicting one or more problems from the plurality of problems, wherein the one or more problems comprises the plurality of problems occurring more than a pre-defined number of times, wherein the one or more problems is predicted before receiving a communication from the customer. The one or more processors may apply one or more graph analytics techniques on the subset of data structures to determine one or more observations associated with the subset of data structures, wherein the one or more observations corresponds to the one or more problems occurring more than the pre-defined number of times. The one or more processors may further transmit a notification comprising the one or more observations pertaining to the query, to a user-computing device associated with a customer care agent who will receive the communication from the customer via a communication network, wherein the notification is transmitted before receiving the communication from the customer.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments of the method and the system may be implemented, in accordance with at least one embodiment;

FIG. 2 is a block diagram that illustrates an application server configured to perform analysis of customer care data, in accordance with at least one embodiment;

FIG. 3 illustrates a protocol architecture that is utilized for analyzing customer care data, in accordance with at least one embodiment;

FIG. 4 illustrates an exemplary scenario of implementation of the protocol architecture 300 in a customer care domain, in accordance with at least one embodiment;

FIG. 5 is a layered block diagram illustrating a semantic web architecture, in accordance with at least one embodiment;

FIG. 6 is a flowchart illustrating a method to determine problems faced by a customer associated with a product, in accordance with at least one embodiment;

FIG. 7 is a data structure, illustrating relationship between the plurality of parameters, in accordance with at least one embodiment;

FIG. 8 is a flowchart illustrating a method for analyzing the customer care data, in accordance with at least one embodiment; and

FIGS. 9A, 9B, 9C, 9D, 9E, and 9F illustrate example user interface 900 presented on the user-computing device 108, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

“Customer care data” refers to data obtained from a plurality of data sources. In an embodiment, the customer care data relates to data from various domains. In an embodiment, the customer care data corresponds to data received from the plurality of data sources. In an embodiment, the customer care data may be obtained from structured data sources, semi-structured data sources, or unstructured data sources. The customer care data comprises a plurality of parameters received from the plurality of data sources.

A “parameter” refers to an attribute associated with an entity for which data is being collected. In an embodiment, the attribute may have different values for different entities. Further, the attribute may vary based on a type of entity. For example, if the entity corresponds to a customer, the parameter may correspond to customer ID, customer name, customer location, customer email, product name, and service name, and problem reported. Similarly, if the entity corresponds to a patient in a healthcare domain, the parameter may correspond to patient ID, patient name, and treatment undergone by the patient.

“Semantic web protocols” refer to a stack of protocols that are used for determining relationships among parameters in the customer care data. In an embodiment, the semantic web protocols are built over the foundation of Resource Description Framework (RDF), Uniform Resource Identifiers (U RI's), XML, and XML namespaces. The semantic web protocols represent each parameters as a RDF triple consisting of a subject, a predicate, and an object. Further, the semantic web protocols support the RDF schema language (RDFS) and web ontology language (OWL). Examples of the one or more semantic web protocols include, but not limited to, Resource Descriptive Framework language, Web Ontology Language, Ontology Inference Layer, DARPA Agent Markup Language, Web Services Modeling Language, and Web Services Semantics.

A “data structure” refers to a collection of data stored in a memory. In an embodiment, various operations may be performed to manipulate the data structures. Some examples of data structures include, but are not limited to, a matrix, an array, a record, a hash table, a union, graphs, and linked list. In an embodiment, the data structure as disclosed in the method and the system may refer to a graph. The graph comprises of a plurality of nodes and a plurality of edges. The plurality of data structures may represent a relationship between the plurality of parameters. In an embodiment, a set of RDF triplets represents the graph. Each of the RDF triplets is represented as <s, p, o> (subject, predicate, object). Further, in the graph, each RDF triplet is represented as an edge in the graph. Thus, semantic data modeling is performed over the plurality of data structures to infer one or more facts associated with the plurality of parameters based on one or more semantic web protocols. In an embodiment, the plurality of data structures are created based on one or more machine learning techniques, a domain ontology, an ontology vocabulary, and a plurality of domain specific rules.

A “weight” refers to a degree of importance assigned to each parameter from the plurality of parameters. In an embodiment, if the weight assigned to the first parameter is higher as compared to the weight assigned to the second parameter, then the first parameter has higher importance than the second parameter.

A method for deriving one or more observations between a plurality of parameters in a customer care data is described. The method receives the customer care data from a plurality of data sources and transforms the customer care data to create a plurality of data structures utilizing one or more semantic web protocols. The plurality of data structures represent a relationship between one or more parameters in the customer care data. In an embodiment, the method extracts a subset of data structures from the plurality of data structures based on a query received via a query interface. The method applies one or more graph analytic techniques on the subset of data structures to identify a one or more observations associated with the subset of data structures. In an embodiment, based on the applied one or more graph analytics techniques, the method displays a visualization indicative of the one or more observations associated with the subset of data structures.

The method further comprises creating, by the one or more processors, the plurality of data structures based on a domain ontology, an ontology vocabulary, a plurality of domain specific rules, and one or more machine learning techniques. In an embodiment, the one or more semantic web protocols comprise Resource Descriptive Framework language, Web Ontology Language, Ontology Inference Layer, DARPA Agent Markup Language, Web Services Modeling Language, and Web Services Semantics. In an embodiment, the query interface supports at least one of a query language including Simple Protocol and RDF Query Language, SeRQL, RDQL, R-Device, and Versa. In an embodiment, the plurality of data structures represent a plurality of graphs. Each graph from the plurality of graphs is formed by a set of nodes and a set of edges. In an embodiment, the set of nodes correspond to the plurality of parameters and the set of edges correspond to the relationship between the plurality of parameters. In an embodiment, each RDF triplet is represented by three attributes, including a subject, a predicate, and an object, associated with each parameter.

In an embodiment, the one or more graph analytics techniques comprise graph clustering, graph-based entity ranking, linear regression, graph segmenting, spectral analysis, temporal analysis, and one or more machine learning techniques. In an alternate embodiment, the one or more graph analytics techniques comprise assigning a weight to each of the plurality of parameters. Further, in an embodiment the one or more graph analytics techniques comprise dynamically updating the weight assigned to each parameter of the plurality of parameters based on a constant value and a time period. In an alternate embodiment, the customer care data received from the plurality of data sources comprises of a plurality of problems faced by a customer while operating a product. The plurality of problems correspond to the plurality of parameters.

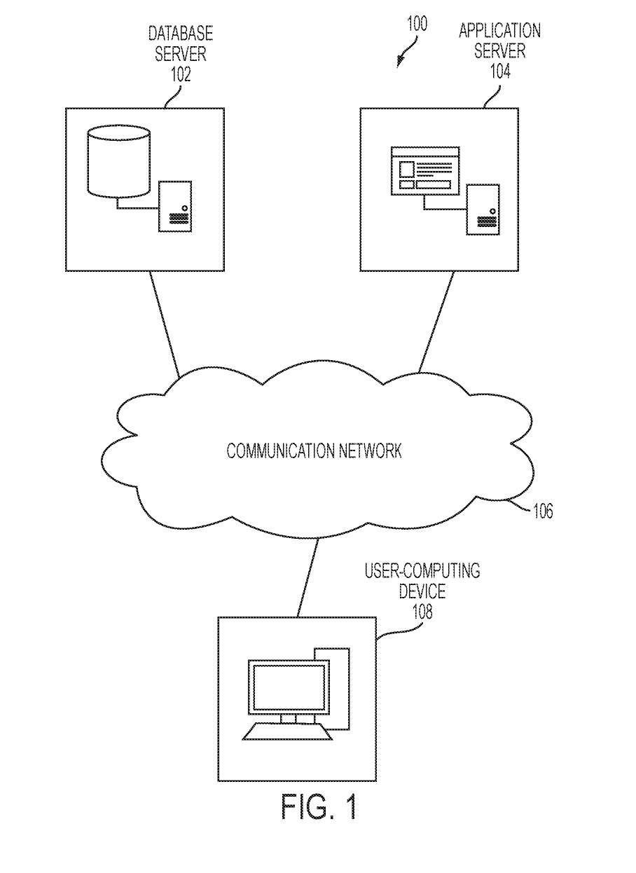

FIG. 1 is a block diagram that illustrates a system environment 100 in which various embodiments of methods and systems may be implemented in accordance with at least one embodiment. The system environment 100 includes a database server 102, an application server 104, a communication network 106, and a user-computing device 108. The database server 102, the application server 104, and the user-computing device 108 are communicatively coupled to each other via the communication network 106. In an embodiment, the application server 104 communicates with the database server 102 using one or more protocols such as, but not limited to, Open Database Connectivity (ODBC) protocol and Java Database Connectivity (JDBC) protocol. In an embodiment, the user-computing device 108 communicates with the application server 104, via the communication network 106.

In an embodiment, the database server 102 may be configured to receive observed values of the plurality of parameters from the plurality of data sources. In an embodiment, a type of the plurality of parameters may be dependent on the domain for which the data is being received. For example if the domain corresponds to customer care management systems, the database server 102 may receive the data associated with the plurality of customers in a structured manner. In such a scenario, the plurality of parameters may include customer id, customer name, customer location, customer email, product name, service name, and problem reported. In an embodiment, the plurality of data sources may comprise, but are not limited to, a plurality of structured data sources, a plurality of semi-structured data sources, and a plurality of unstructured data sources. In an embodiment, the database server 102 may be configured to store the values of the plurality of parameters. The database server 102 is realized through various technologies such as, but not limited to, MongoDB, RDF Data Store, Virtuosa Data Store, Microsoft® SQL Server, Oracle®, IBM DB2®, Microsoft Access®, PostgreSQL®, MySQL® and SQLite®, and the like.

A person with ordinary skills in the art will understand that the scope of the disclosure is not limited to the database server 102 as a separate entity. In an embodiment, the functionalities of the database server 102 may be integrated into the application server 104.

In an embodiment, the application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through various types of application servers such as, but not limited to, a Java application server, a .NET framework application server, a Base4 application server, a PHP framework application server, or any other application server framework.

In an embodiment, the application server 104 may be configured to extract the plurality of parameters in the customer care data from the database server 102. In an embodiment, the application server 104 may further be configured to assign a weight to each of the plurality of parameters. In an embodiment, the application server 104 may be configured to transform the plurality of parameters in the customer care data to create the plurality of data structures. In an embodiment, the application server 104 may utilize the one or more semantic protocols to create the plurality of data structures. The application server 104 is configured to receive one or more queries from the user-computing device 108. The application server 104 may be configured to extract the subset of data structures from the plurality of data structures based on the one or more queries. Further, in an embodiment, the application server 104 may be configured to apply one or more graph analytics techniques and/or one or more machine learning techniques to identify one or more observations associated with the subset of data structures. In an embodiment, the application server 104 may be configured to provide a visualization of the one or more observations associated with the subset of data structures.

A person having ordinary skill in the art will appreciate that the scope of the disclosure is not limited to realizing the application server 104 and the user-computing device 108 as separate entities. In an embodiment, the application server 104 may be realized as an application program installed on and/or running on the user-computing device 108 without departing from the scope of the disclosure.

In an embodiment, the communication network 106 corresponds to a communication medium through which the database server 102, the application server 104, and the user-computing device 108 communicate with each other. Such a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

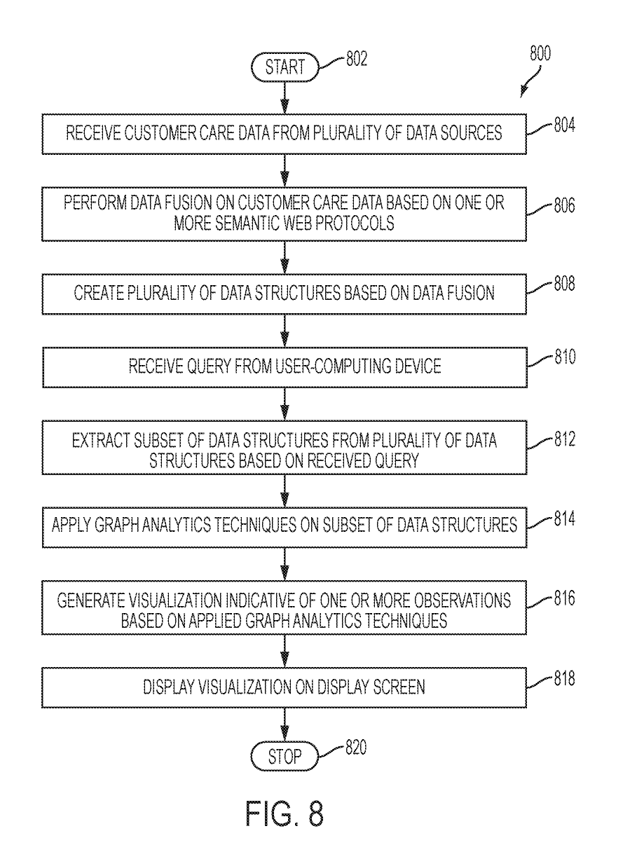

In an embodiment, the user-computing device 108 may refer to a computing device used by a user. The user-computing device 108 may include one or more processors and one or more memories. The one or more memories may include computer readable code that may be executable by the one or more processors to perform predetermined operations. In an embodiment, the user-computing device 108 may present the query interface (received from the application server 104) to the user to input the one or more queries. In an embodiment, the user-computing device 108 may include hardware and software to display the visualization of the one or more observations received from the application server 104. Example user-interfaces presented on the user-computing device 108 for displaying the one or more observations associated with the subset of data structures have been explained later in conjunction with FIG. 8A and FIG. 8B. In an embodiment, the user-computing device 108 may be utilized by users from various domains such as, customer care, healthcare, financial, transportation, education sector, and the like. Examples of the user-computing device 108 may include, but are not limited to, a personal computer, a laptop, a personal digital assistant (PDA), a mobile device, a tablet, or any other computing device.

In an embodiment, an expert computing device (not shown) refers to a computing device used by an expert user. The expert computing device comprises of one or more processors and one or more memories. The one or more memories may include computer readable code that is executable by the one or more processors to perform predetermined operations. In an embodiment, the expert user stores the domain knowledge, the domain specific language, the domain specific rules, and the domain ontology in the expert computing device. Examples of the expert computing devices include, but are not limited to, a personal computer, a laptop, a personal digital assistant (PDA), a mobile device, a tablet, or any other computing device.

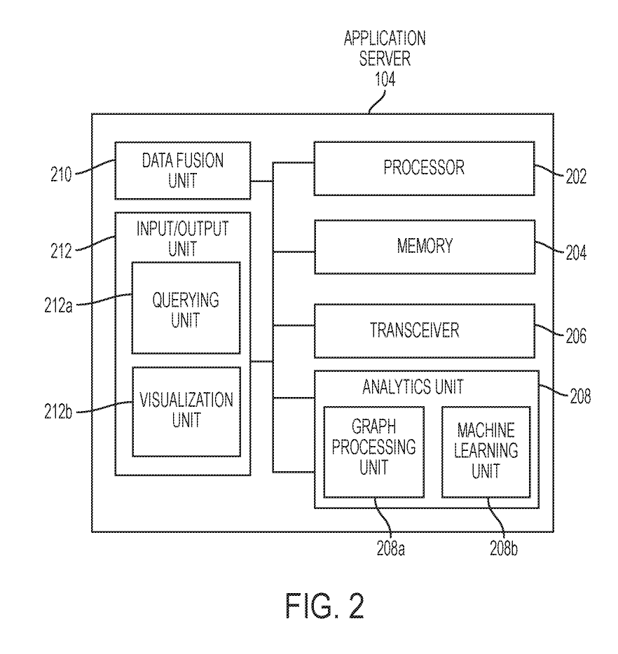

FIG. 2 is a block diagram that illustrates an application server 104 configured to perform analysis of customer care data, in accordance with at least one embodiment. FIG. 2 is explained in conjunction with elements from FIG. 1. In an embodiment, the application server 104 may include a processor 202, a memory 204, a transceiver 206, an analytics unit 208, a data fusion unit 210, and an input/output unit 212. The analytics unit 208 may further comprise a graph processing unit 208a and a machine learning unit 208b. The processor 202 may be communicatively connected to the memory 204, the transceiver 206, the analytics unit 208, the data fusion unit 210, and the input/output unit 212. The transceiver 206 may be communicatively coupled to the communication network 106.

The processor 202 comprises suitable logic, circuitry, interfaces, and/or code that is configured to execute a set of instructions stored in the memory 204. The processor 202 is implemented based on a number of processor technologies known in the art. The processor 202 is configured to execute the set of instructions in conjunction with the analytics unit 208, the data fusion unit 210, and the I/O unit 212. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 comprises suitable logic, circuitry, interfaces, and/or code that is configured to store the set of instructions, which are executed by the processor 202, the analytics unit 208, and the data fusion unit 210. In an embodiment, the memory 204 is configured to store one or more programs, routines, or scripts that are executed by the graph processing unit 208a and the machine learning unit 208b. In an embodiment, the memory 204 is configured to store one or more graph processing algorithms such as graph clustering, graph-based entity ranking, linear regression, graph segmenting, and temporal analysis. In an embodiment, one or more machine learning techniques are stored in the memory 204. The memory 204 is implemented based on a Random Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that is configured to receive the plurality of parameters in the customer care data from the database server 102, via the communication network 106. The transceiver 206 is further configured to transmit the visualization, indicative of the one or more observations associated with the subset of data structures, to the user-computing device 108, via the communication network 106. In an embodiment, a notification comprising the one or more observations pertaining to the query may be transmitted to the user-computing device associated with a customer care agent who will receive the communication from the customer via a communication network. In an embodiment, the notification may be transmitted before receiving the communication from the customer. The transceiver 206 is further configured to receive the query via the user-computing device 108. The transceiver 206 implements one or more known technologies to support wired or wireless communication with the communication network 106. In an embodiment, the transceiver 206 includes, but is not limited to, an antenna, a radio frequency (RF) transceiver, one or more amplifiers, a tuner, one or more oscillators, a digital signal processor, a Universal

Serial Bus (USB) device, a coder-decoder (CODEC) chipset, a subscriber identity module (SIM) card, and/or a local buffer. The transceiver 206 communicates via wireless communication with networks, such as the Internet, an Intranet and/or a wireless network, such as a cellular telephone network, a wireless local area network (LAN) and/or a metropolitan area network (MAN). The wireless communication uses any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The analytics unit 208 comprises suitable logic, circuitry, interfaces, and/or code that is configured to implement one or more graph processing techniques and one or more machine learning techniques in conjunction with the graph processing unit 208a and the machine learning unit 208b, respectively. The analytics unit 208 is configured to determine the one or more observations associated with the subset of data structures by applying one or more graph processing techniques and/or one or more machine learning techniques on the subset of data structures.

The graph processing unit 208a comprises suitable logic, circuitry, interfaces, and/or code that is configured to apply one or more graph processing techniques on the subset of data structures. The graph processing unit 208a is configured to assign a weight to each parameter of the plurality of parameters. In an alternate embodiment, the graph processing unit 208a is configured to dynamically update the weight assigned to each of the plurality of parameters. In an embodiment, the graph processing unit 208a is configured to implement graph clustering, graph based segmenting, and graph based parameter ranking based on the one or more graph processing algorithms. The graph processing unit 208a is configured to apply one or more graph processing techniques on the subset of data structures to determine one or more observations associated with the subset of data structures.

The machine learning unit 208b comprises suitable logic, circuitry, interfaces, and/or code that is configured to implement one or more machine learning techniques. Examples of machine learning techniques include Q-learning, similarity learning, clustering, decision tree learning, temporal difference learning and the like. The machine learning unit 208b is configured to determine one or more observations associated with the subset of data structures by applying one or more machine learning techniques on the subset of data structures.

The data fusion unit 210 comprises suitable logic, circuitry, interfaces, and/or code that is configured to create the plurality of data structures from the plurality of parameters in the customer care data. The data fusion unit 210 is further configured to determine the dependencies between the plurality of parameters. In an embodiment, the data fusion unit 210 utilizes one or more semantic web protocols to determine the dependencies between the plurality of parameters. In an embodiment, the data fusion unit 210 is further configured to perform extract, transform, and load operations on the plurality of parameters in order to determine the dependencies. Further, the data fusion unit 210 is configured to extract the subset of data structures from the plurality of data structures based on a query received from the user-computing device 108.

The Input/Output (I/O) unit 212 comprises suitable logic, circuitry, interfaces, and/or code that is configured to receive an input or transmit an output to the user-computing device 108. The I/O unit 212 further comprises of a querying unit 212a and a visualization unit 212b. In an embodiment, the I/O unit 212 operates in conjunction with the transceiver 206 to transmit and receive the visualization and the query, respectively. In an alternate embodiment, a user directly accesses the application server 104 (i.e., the user utilizes the input/output devices of the application server 104 for providing the query and the receiving the visualizations). In such a scenario, the input/output unit 212 comprises of various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

The querying unit 212a comprises suitable logic, circuitry, interfaces, and/or code that is configured to receive plurality of queries from the user-computing device 108. The querying unit 212a is configured to query the plurality of data structures and extract the subset of data structures pertaining to the query. In an embodiment, the querying unit 212a is configured to process the plurality of queries in parallel. Parallel execution of plurality of queries indicate that plurality of queries are executed by the querying unit 212a at any time instant. In an embodiment, the querying unit 212a provides an interactive query interface to the user to input the query. In an embodiment, third party querying tools such as, BigQuery are utilized to query the plurality of data structures. In an alternate embodiment, open source query engines such as Fuseki are utilized to query the plurality of data structures.

The visualization unit 212b comprises suitable logic, circuitry, interfaces, and/or code that is configured to display one or more observations associated with the subset of data structures. In an embodiment, the visualization unit 212b is configured to receive one or more observations associated with the subset of structures from the analytics unit 208. The visualization unit 212b is configured to generate one or more visualizations associated with the one or more observations using one or more third party visualization tools. In an embodiment, an embedded Application Programming Interface (API) may be provided by the third party tools to generate the one or more visualizations. In an embodiment, a Java script such as “chart.js” may be utilized by the visualization unit 212b to generate the one or more visualizations. Examples one or more visualizations include a bar graph, a pie chart, a scatter chart, an area chart and the like. Examples of one or more third party visualization tools include Gephi, Power BI, Tableau and the like.

In operation, the database server 102 is configured to receive the plurality of parameters in the customer care data from the plurality of data sources, via the communication network 106. Examples of the plurality of data sources may include, but not limited to, a video, an image, a document, a sensor data stream, an audio file, a social media stream, a relational database, and graphical data representation. Further, examples of the plurality of data sources capture data from structured data sources, semi-structured data sources, and unstructured data sources. In an embodiment, the transceiver 206 is configured to receive the plurality of parameters in the customer care data from the plurality of sources, via the communication network 106. Further, the transceiver 206 is configured to store the plurality of parameters in the customer care data in the database server 102.

In an embodiment, the plurality of data sources may be acquired using one or more hardware/software components. For example, in an embodiment, if the data source is an email log, then a JavaScript may be utilized to extract the data from the email log. In another scenario, if the data source is a telephone call that is received in a customer care center, then the data in the telephone call may be extracted using an audio sensor installed at the data source (telephone). In an embodiment, speech recognition techniques may be utilized to translate the captured audio data in to a text transcript which may later be stored in a relational database.

A person skilled in the art will understand that the capturing of customer care data from the plurality of data sources may not be limited to the examples illustrated herein. The examples described herein are only for illustrative purposes and should not be considered to limit the scope of the disclosure in any manner.

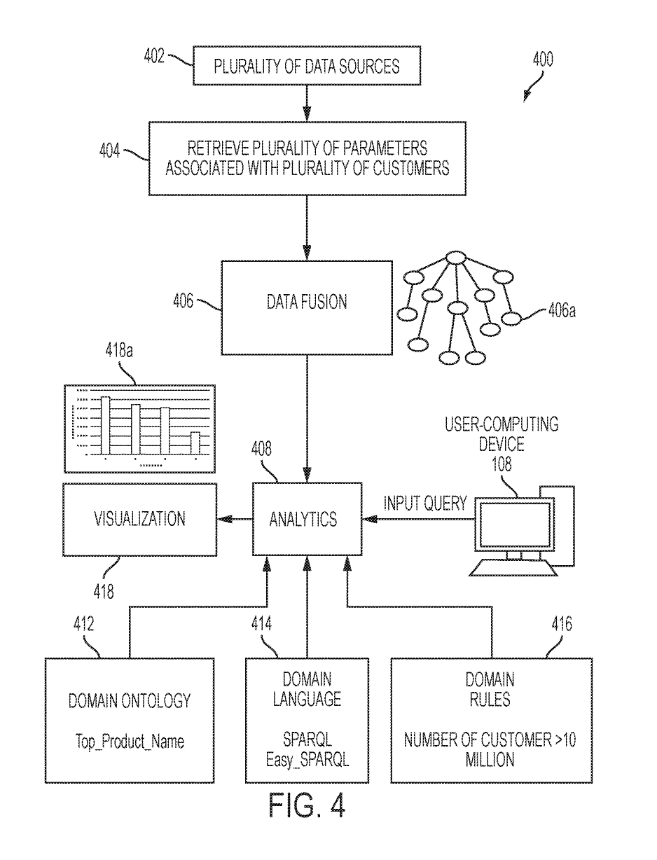

The data fusion unit 210 is configured to extract the plurality of parameters of the customer care data stored in the database server 102, via the communication network 106. The data fusion unit 210 is further configured to perform data fusion on the plurality of parameters using one or more semantic web protocols. The one or more semantic web protocols are implemented in conjunction with the semantic web architecture. The detailed semantic web architecture is described in conjunction with FIG. 4. The data fusion unit 210 is configured to perform data fusion such that the plurality of parameters are transformed into the plurality of data structures.

In an embodiment, the querying unit 212a is configured to receive a query via the query interface from the user-computing device 108. Based on the received query, the data fusion unit 210 is configured to extract a subset of data structures from the plurality of data structures. In response to the extraction of the subset of data structures, the graph processing unit 208a is configured to apply one or more graph analytics techniques on the subset of data structures. In response to the application of the one or more graph analytics techniques, the graph processing unit 208a is configured to determine one or more observations associated with the subset of data structures. Examples of the one or more graph analytics techniques include, but not limited to, graph clustering, graph-based parameter ranking, linear regression, graph segmenting, and temporal analysis.

In an alternate embodiment, the machine learning techniques are employed on the subset of data structures by the machine learning unit 208b. One or more machine learning techniques are extracted from the memory 204 and the machine learning unit 208b utilizes the one or more machine learning techniques to determine one or more observations associated with the subset of data structures. Examples of one or more machine learning techniques include Q-learning, similarity learning, clustering, decision tree learning, temporal difference learning and the like.

In response to the application of the one or more graph analytics techniques and/or one or more machine learning techniques, the analytics unit 208 is configured to determine one or more observations associated with the subset of data structures. Further, in an embodiment, the visualization unit 212b is configured to create one or more visual representations of the one or more observations pertaining to the subset of the data structures based on the application of the one or more graph analytics techniques and/or one or more machine learning techniques. In an embodiment, the visualization unit 212b is configured to transmit the one or more visual representations to the user-computing device 108, where the user-computing device 108 is configured to display the one or more visual representations on the display screen of the user-computing device 108. In an alternate embodiment, the one or more visual representations are displayed on the display screen of the application server 104. In an embodiment, the one or more visual representations may be stored in the memory 204 for later retrieval by the visualization unit 212b. In an embodiment, a notification comprising the one or more observations pertaining to the query may be transmitted to the user-computing device associated with a customer care agent who will receive the communication from the customer via a communication network. In an embodiment, the notification may be transmitted before receiving the communication from the customer.

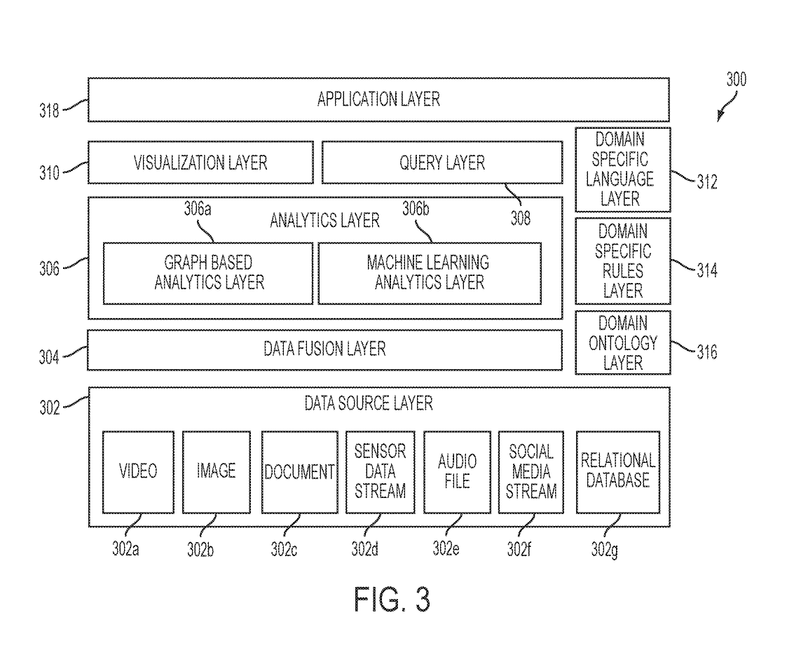

FIG. 3 illustrates a protocol architecture 300 that is utilized for analyzing customer care data, in accordance with at least one embodiment. FIG. 3 is explained in conjunction with elements from FIG. 1 and FIG. 2.

The protocol architecture 300 comprises a data source layer 302, a data fusion layer 304, an analytics layer 306, a query layer 308, a visualization layer 310, a domain specific language layer 312, a domain specific rule layer 314, a domain ontology layer 316, and an application layer 318. The data source layer 302 further comprises of a plurality of data sources received from a plurality of data sources such as, but not limited to, a video 302a, an image 302b, a document 302c, a sensor data stream 302d, an audio file 302e, a social media stream 302f, a relational database 302g, and graphical data representation 302h, to receive the customer care data. The analytics layer 306 further comprises a graph based analytics layer 306a and a machine learning analytics layer 306b and that are utilized for analysis of the customer care data.

### Data Source Layer

The data source layer 302 is configured to receive the customer care data from the plurality of data sources, via the communication network 106. In an embodiment, the customer care data may include data from different domains. For example, the customer care data may include data from social media platforms, customer care related data, healthcare data and the like. Further, the data source layer 302 may receive data from plurality of different sources such as, but are not limited to, video sources (e.g., YouTube), image database, sensor streams, audio streams, and text databases. In an embodiment, the data source layer 302 may receive the data in accordance with the communication protocols applicable with the data streams. For example, the data source layer 302 may receive the video in accordance with one or more streaming protocols such as Real Time Streaming Protocol (RTSP), HTML5, and the like, when the data corresponds to audio data or video data. In an embodiment, the plurality of data sources capture data from the structured data sources, the semi-structured data sources, and the unstructured data sources via the plurality of sensors.

When the data is received from the structured data sources, all the parameters in the data source are organized according to the semantics associated with the plurality of parameters. The schema used for defining all the parameters of the structured data sources have a same defined format, pre-defined length, and all the data have same order. Examples of the structured data sources include, but are not limited to, SQL databases, MySQL databases, and HDFS databases.

When the data is received from the semi-structured data sources, all the parameters in the data source are organized in accordance with the semantic associated with the plurality of parameters. All the similar parameters in the semi-structured data sources are grouped together. However, the parameters within the same group may not have the same attributes. For example, the parameters may correspond to mobile phones such as, “HTC desire S”, “Samsung S6”, and “Nokia Lumia 920”. As all the parameters correspond to the mobile phones, thus all the mobile phones are grouped together. However, the specifications of each of the mobile phones may not be the same. Examples of the semi-structured data sources include, but are not limited to, file systems, such as bibliographic data and web data and data exchange formats, such as Electronic Data Interchange (EDI) and scientific data.

When the data is received from the unstructured data sources, the parameters in the data source may be of any data type. Further, the parameters need not necessarily follow a pre-defined format or sequence. Examples of the unstructured data sources include, but not limited to, sensor streams, textual conversations, social media, self-care portals, e-mail, audio feeds, video feeds, images, databases.

Based on the customer care data received from the plurality of data sources, the data source layer 302 may be configured to store the customer care data in the database server 102. In an embodiment, the plurality of parameters in the customer care data are stored in such a manner that the plurality of parameters from same application area are grouped together.

A person with ordinary skills in the art will understand that the scope of the disclosure is not limited to the functionalities of the data source layer 302 as discussed herein. The one or more functionalities described herein are only for illustrative purposes and should not be considered to limit the scope of the disclosure in any manner.

### Data Fusion Layer

The data fusion layer 304 may be configured to receive the plurality of parameters from the data source layer 302. The data fusion layer 304 may be configured to utilize the one or more semantic web protocols to perform the data fusion of the plurality of parameters received from the data source layer 302. In an embodiment, the data fusion unit 210 may utilize a RDF data model to perform the data fusion of the plurality of parameters s. Examples of the one or more semantic web protocols associated with the RDF model include, but not limited to, Resource Descriptive Framework language, Web Ontology Language, Ontology Inference Layer, DARPA Agent Markup Language, Web Services Modeling Language, and Web Services Semantics.

The data fusion unit 210 is configured to perform the data fusion on the plurality of parameters in the customer care data. While performing the data fusion, the data fusion unit 210 may be configured to determine dependencies within the plurality of parameters. In order to determine the dependencies, the data fusion unit 210 may be configured to create the plurality of data structures from the plurality of parameters. In an embodiment, each data structure may correspond to a graph. In an embodiment, each of the set of nodes within the graph may represent each of the plurality of parameters and each of the set of edges within the graph may represent the dependency within the nodes.

In order to perform the data fusion, the data fusion unit 210 may utilize the one or more semantic web protocols to determine knowledge of the domain associated with the plurality of parameters. In another embodiment, the data fusion unit 210 may receive the knowledge from one or more expert computing devices (being operated by domain experts). Thus, the data fusion unit 210 may utilize the one or more semantic web protocols to capture the semantic heterogeneity in the plurality of parameters in the customer care data. In an embodiment, the data fusion unit 210 may be configured to perform extract, transform, and load operations on the plurality of parameters in the customer care data to convert each of the plurality of parameters to an RDF form. In an embodiment, the plurality of parameters represented in the RDF form may be alternatively annotated as the plurality of data structures.

Further, based on the plurality of data structures created using the one or more semantic web protocols, the data fusion layer 304 in conjunction with the data fusion unit 210 may generate a semantic graph representation of the plurality of data structures. In an embodiment, the semantic graph representation represents a single data structure generated by fusing the plurality of data structures. In an embodiment, the data fusion unit 210 may further be configured to perform at least one transformation operation on each parameter from the plurality of parameters in the plurality of data structures to generate the semantic graph representation.

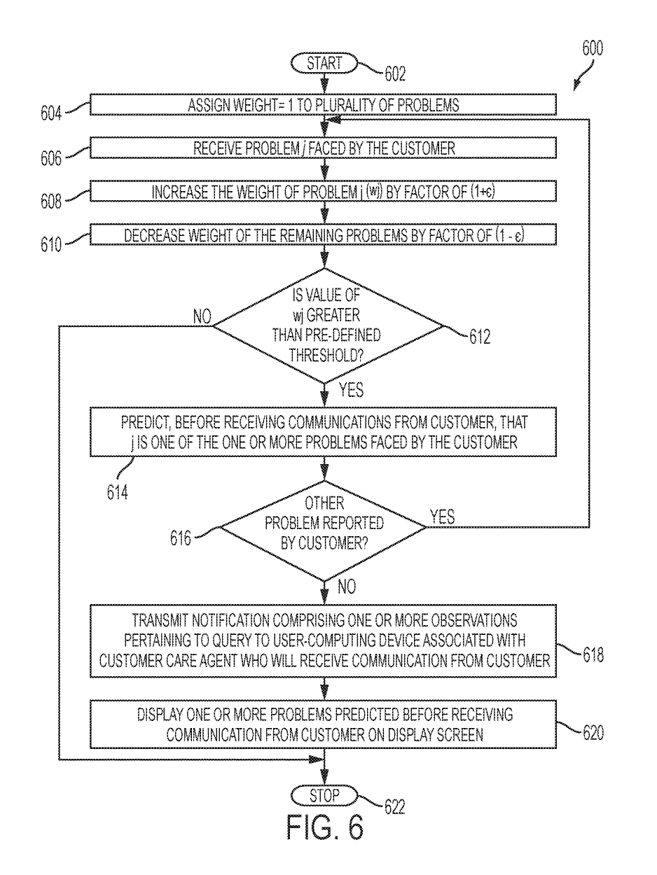

Thus, the data fusion layer 304 may be implemented in such a manner that the data fusion unit 210 is configured to represent data in the RDF form, and generate the semantic graph representation of the plurality of data structures. In an embodiment, the data fusion layer 304 may be implemented in such a manner that the semantic graph representation is utilized to capture implicit dependencies between the plurality of parameters. An illustrative example to generate the semantic graph representation of the plurality of data structures and capture the implicit dependencies between the plurality of parameters utilizing the one or more semantic web protocols is explained later in conjunction with FIG. 6. Thus, the data fusion layer 304 is implemented in such a manner that the plurality of parameters in the customer care data are semantically fused to generate the semantic graph representation.

A person with ordinary skills in the art will understand that the scope of the disclosure is not limited to the functionalities of the data fusion layer 304 as discussed herein. The one or more functionalities described herein are only for illustrative purposes and should not be considered to limit the scope of the disclosure in any manner.

### Analytics Layer

Based on the semantic graph representation generated by the data fusion layer 304, the analytics layer 306 may be configured to analyze the semantic graph representation and may further determine the one or more observations to be displayed on a display screen. The analytics layer 306 may be configured to receive the one or more queries from the user, based on which the analytics layer 306 may apply the one or more machine learning techniques and the one or more graph processing techniques to determine the one or more observations. The analytics layer 306 may include the graph based analytics layer 306a and the machine learning analytics layer 306b that may be utilized to analyze the semantic graph representation generated by the data fusion layer 304. In an embodiment, the machine learning analytics layer 306b may be configured to apply the one or more machine learning techniques, such as clustering, classification, and prediction techniques on the semantic graph representation to derive the one or more observations. In an embodiment, the graph based analytics layer 306a in conjunction with the graph processing unit 208a may be configured to implement the one or more graph analytics techniques on the semantic graph representation to derive the one or more observations. Examples of the one or more graph analytics techniques include, but are not limited to, graph clustering, graph-based parameter ranking, linear regression, graph segmenting, and temporal analysis. In an embodiment, the one or more observations derived by applying the one or more graph analytics techniques correspond to one or more implicit dependencies between the plurality of parameters in the customer care data.

A person with ordinary skills in the art will understand that the scope of the disclosure is not limited to the functionalities of the analytics layer 306 as discussed herein. The one or more functionalities described herein are only for illustrative purposes and should not be considered to limit the scope of the disclosure in any manner.

A person with ordinary skills in the art will understand that apart from the one or more machine learning techniques and the one or more graph analytics techniques as discussed herein, one or more analytics techniques that may be application specific may be developed and may be implemented in the analytics layer 306 by the analytics unit 208. The one or more machine learning techniques and the one or more graph analytics techniques as discussed herein are described herein only for illustrative purposes and should not be considered to limit the scope of the disclosure in any manner.

### Machine Learning Analytics Layer

The machine learning analytics layer 306b may be configured to receive the semantic graph representation from the data fusion layer 304. The machine learning analytics layer 306b in conjunction with the machine learning unit 208b may be configured to implement the one or more machine learning techniques on the semantic graph representation. The machine learning unit 208b may be configured to create a tabular representation of the plurality of parameters based on the semantic graph representation. The machine learning unit 208b may further be configured to apply the one or more machine learning techniques on the tabular representation. An example of the one or more machine learning techniques includes, but is not limited to, a temporal learning technique. Based on the applied one or more machine learning techniques on the tabular representation, the machine learning unit 208b may further be configured to determine the one or more observations associated with the plurality of parameters represented in the tabular representation.

In an implementation scenario, consider the temporal learning technique is implemented in a customer care domain to determine a preferred communication channel of a customer. In the customer care domain, plurality of customers uses plurality of communication channels. Further, each communication channel has an associated cost. For example, the cost of communication over a telephone line channel is higher as compared to the cost of communicating over a chat channel or an email channel. In order to determine a preferred communication channel, machine learning analytics layer 306b in conjunction with the machine learning unit 208b may utilize a temporal sequence model such as Hidden Markov Model (HMM) to determine a change in preference of the communication channel during a time interval. In an embodiment, the machine learning analytics layer 306b may be configured to apply the HMM technique on the subset of data structures to determine the preferred communication medium. Further, the machine learning unit 208b may be configured to utilize the HMM to determine a probability of choosing a particular communication channel by the customer. The probability is determined based on a previous interaction of the customer and a context of interaction using the particular communication channel determined from the plurality of data structures. The probability signifies that the particular customer has an inherent preference to use the particular communication channel and will continue to use the particular communication channel unless there is a need to select a more interactive communication channel.

For example, consider a scenario where a customer reports a problem by email. However, the customer is not satisfied with the resolution even after repeated interactions via the email channel. Thus, the customer decides to change the communication channel from email to the telephone channel. Accordingly calls a customer service center to resolve the problem. In such a scenario, the machine learning analytics layer 306b may implement temporal learning technique to predict that the preferred communication channel of the customer will change from the email communication channel to the telephone communication channel.

A person with ordinary skills in the art will understand that the scope of the disclosure is not limited to the functionalities of the machine learning analytics layer 306b as discussed herein. The one or more functionalities described herein are only for illustrative purposes and should not be considered to limit the scope of the disclosure in any manner.

### Graph Based Analytics Layer

In an embodiment, the graph based analytics layer 306a may implement the graph clustering technique on the semantic graph representation. While implementing the graph clustering technique, the graph processing unit 208a is configured to group a set of parameters that are similar to each other. For example, consider that the plurality of parameters correspond to a plurality of mobile phones. Thus, the graph processing unit 208a is configured to group mobile phones based on the manufacturer of the mobile phone. In an embodiment, the graph processing unit 208a determines the similarity between two parameters by determining a distance between the two parameters. The distance between parameters represents a degree of similarity between the two parameters. In an embodiment, a cosine function is applied on the parameters to determine the distance between the two parameters. In another exemplary scenario, the graph based analytics layer 306a may implement a parameter ranking technique to derive the one or more observations based on the plurality of parameters. The parameter ranking technique assigns a rank to the parameter with respect to remaining parameters.

In an embodiment, the graph based analytics layer 306a in conjunction with the graph processing unit 208a may implement a spectral ranking technique to assign ranks to the plurality of parameters. In the spectral ranking technique, the graph processing unit 208a constructs a weighted undirected graph of all the parameters. The weighted undirected graph comprises of a plurality of nodes and a plurality of edges. The plurality of nodes corresponds to the plurality of parameters. The plurality of edges corresponds to the relationship between the plurality of parameters. The weight assigned to an edge signifies the strength of the relationship between the parameters connected by the edge. In an embodiment, the graph processing unit 208a projects the weighted undirected graph in a latent space to determine a Euclidian distance. An example of the latent space includes a Laplacian embedding of graphs spanned by eigen vectors of an associated Laplacian matrix. In an embodiment, the Laplacian matrix is derived from an adjacency matrix of the weighted undirected graph. The Euclidian distance between a pair of parameters approximates average connectivity between the pair of parameters in the latent space. The graph processing unit 208a may be configured to approximate the average connectivity between the pair of parameters by determining one or more edges between the parameters and the weight associated with each of the one or more edges. In an embodiment, the graph processing unit 208a may further be configured to determine the relationship between the pair of parameters based on the latent space and the Euclidian distance.

A person skilled in the art will understand that the graph based analytics layer 306a may be implemented on a separate hardware such as the graph processing unit 208a. Further, a person with ordinary skills in the art will understand that the scope of the disclosure is not limited to the functionalities of the graph based analytics layer 306a as discussed herein. The one or more functionalities described herein are only for illustrative purposes and should not be considered to limit the scope of the disclosure in any manner.

### Query Layer

The query layer 308 provides a query interface to extract the subset of data structures from the plurality of data structures stored in the data fusion layer 304. The plurality of data structures correspond to the plurality of semantic graph representations of the plurality of parameters. In an embodiment, the query interface supports at least one of a query language including Simple Protocol and RDF Query Language (SPARQL), SeRQL, RDQL, R-Device, and Versa. The query layer 308 is configured such that interspersed queries may be executed on the plurality of data structures. Thus, a progressive data exploration is possible using the query layer 308. An example of a query engine that supports extraction of the subset of data from the plurality of data structures using SPARQL is Fuseki.

In an exemplary scenario, the SPARQL is utilized to query the plurality of data structures. The SPARQL is a SQL-like language for querying data that is stored in RDF form. The plurality of data structures such as the semantic graph representation generated by the data fusion layer 304 is stored in the RDF form. In an embodiment, the data fusion unit 210 may be configured to utilize TURTLE syntax in order to query the plurality of data structures. For the purpose of implementation, the query layer 308 utilizes Fuseki and JENA to provide the query interface for querying the plurality of data structures.

Thus, the query layer 308 may enable the user to query the plurality of data structures and extract the subset of data structures that correspond to the data of user interest. The subset of data structures are further utilized by the visualization layer 310 to display the one or more observations pertaining to the subset of the data structures. In an alternate embodiment, the query may be a script that is input by the user to extract the subset of data structures that correspond to the data of user interest. In another embodiment, the query layer 308 provides an interactive query interface that enables the user to input the query.

A person with ordinary skills in the art will understand that the scope of the disclosure is not limited to the functionalities of the query layer 308 as discussed herein. The one or more functionalities described herein are only for illustrative purposes and should not be considered to limit the scope of the disclosure in any manner.

### Visualization Layer

The visualization layer 310 may be configured to receive the one or more observations pertaining to the subset of the data structures from the analytics layer 306. The visualization layer 310 may be configured such that the visualization unit 212b creates the one or more visual representations of the one or more observations determined by the analytics layer 306. In an embodiment, third party visualization tools are utilized to create the one or more visual representations. Examples of the visual representations include, but not limited to, a bar graph, a pie chart, a scatter plot, an area chart, and a radar chart. For the purpose of implementation of the visualization layer 310, one or more third party tools such as Gephi, semantic web plugin for Gephi, HTML, JSP, JavaScript, and JAVA libraries are used. In an embodiment, such visualizations are transmitted to the user-computing device 108. In an embodiment, an intuitive visualization user interface is provided to the user to view the one or more observations pertaining to the subset of the data structures on a display device. In an alternate embodiment, an interactive visualization is provided to the user to view the one or more observations pertaining to the subset of the data structures on the display device. FIGS. 8A and 8B illustrate example user-interfaces presented on the user-computing device 108 that may display the visual representations of the one or more observations.

A person with ordinary skills in the art will understand that the scope of the disclosure is not limited to the functionalities of the visualization layer 310 as discussed herein. The one or more functionalities described herein are only for illustrative purposes and should not be considered to limit the scope of the disclosure in any manner.

### Domain Specific Language Layer

The domain specific language layer 312 is configured to define one or more domain concepts based on the application domain in which the protocol architecture may be implemented. Further, the domain specific language layer 312 may provide the one or more domain concepts to the query layer 308 and the visualization layer 310 for further processing. For example, in a customer care domain, a concept, such as “Premium customer” may be defined using domain specific rule layer 314 and domain ontology layer 316. The domain specific language layer 312 may implement one or more necessary plugins to enable the concept (Premium customer) to be utilized in the query layer 308 and visualization layer 310 for further processing. In an embodiment, the domain specific language layer 312 may implement user-defined functions for known in the art query languages. Further, in an embodiment, the domain specific language layer 312 may implement an enhanced query engine to define the one or more domain concepts.

A person with ordinary skills in the art would understand that the scope of the disclosure is not limited to the functionalities of the domain specific language layer 312 as discussed herein. The one or more functionalities described herein are only for illustrative purposes and should not be considered to limit the scope of the disclosure in any manner.

### Domain Specific Rule Layer

The domain specific rule layer 314 provides expert knowledge about a domain in the form of one or more rules and conditions associated with each of the plurality of parameters. For example, assigning a constraint on a parameter such as, “age” of the customer to be above 18 and below 90 may correspond to the one or more rules and conditions. Another example of defining the one or more rules and conditions by the domain specific rule layer 314 corresponds to defining a constraint such as a prepaid connection and a postpaid connection for a same service cannot occur together. In an embodiment, the domain specific rule layer 314 may import common knowledge which is applicable to multiple domains and known as common sense ontology (e.g., YAGO) and also import specialized knowledge using the domain ontology layer 316.

A person with ordinary skills in the art would understand that the scope of the disclosure is not limited to the functionalities of the domain specific rule layer 314 as discussed herein. The one or more functionalities described herein are only for illustrative purposes and should not be considered to limit the scope of the disclosure in any manner.

### Domain Ontology Layer

The domain ontology layer 316 is configured to store one or more domain concepts that are utilized by the query layer 308 and the visualization layer 310. The domain ontology layer 316 is configured to store one or more domain concepts associated with the plurality of domains that include, but not limited to, customer care, education, transportation, and healthcare. The domain concepts correspond to one or more semantic concepts created by one or more domain experts, which may be utilized to create the plurality of data structures. For example, in the customer care domain, a domain expert creates a new domain concept known as “GoodSolution”. The “GoodSolution” concept is defined by the domain expert as any “ResolutionType” that solves more than five problems in the devices. Based on the defined domain concept, the user can utilize the defined domain concept to query the plurality of data structures. For example, the user transmits a query such as “show me all agents who employ GoodSolution and solve the problem earliest”. The domain ontology layer 316 in conjunction with the data fusion unit 210 to create one or more complex domain concepts. In an embodiment, the domain concepts are defined dynamically using first-order-logic based operators. The one or more domain concepts are utilized by the data fusion layer 304, the analytics layer 306, the query layer 308, and the visualization layer 310 to determine the one or more observations to be presented on the display screen. In an embodiment, in response to the query received from the query layer 308, the domain ontology layer 316 extracts one or more domain concepts associated with the query and provides the one or more domain concepts to the data fusion layer 304.

A person with ordinary skills in the art would understand that the scope of the disclosure is not limited to the functionalities of the domain ontology layer 316 as discussed herein. The one or more functionalities described herein are only for illustrative purposes and should not be considered to limit the scope of the disclosure in any manner.

### Application Layer

The application layer 318 defines an application area or a domain area for which graphical analysis of customer care data is to be performed based on the different layers of the architecture as explained above. In an embodiment, the application layer is utilized to develop applications, which may be configured to work in accordance with the protocol architecture. Examples of the application area include, but not limited to, transportation, education, healthcare, and customer care. Based on the application area, the data fusion unit 210 may determine the domain specific languages, the domain specific rules and the domain ontology that are utilized by the other layers of the architecture to derive the one or more observations.

A person with ordinary skills in the art will understand that the scope of the disclosure is not limited to the functionalities of the application layer 318 as discussed herein. The one or more functionalities described herein are only for illustrative purposes and should not be considered to limit the scope of the disclosure in any manner.

The data fusion unit 210, the analytics unit 208, the graph processing unit 208a, the machine learning unit 208b, the I/O unit 212, the querying unit 212a, and the visualization unit 212b may perform one or more operations (as discussed above) on the plurality of parameters in accordance with the protocol architecture 300. In an embodiment, the data fusion unit 210 may be configured to work in accordance with the data source layer 302, domain specific language layer 312, domain specific rule layer 314, domain ontology layer 316, and the data fusion layer 304. In an embodiment, the analytics unit 208 may be configured to work in accordance with the analytics layer 306. In an embodiment, the graph processing unit 208a may be configured to work in accordance with the graph based analytics layer 306a. In an embodiment, the machine learning unit 208b is configured to work in accordance with the machine learning analytics layer 306b. In an embodiment, the querying unit 212a is configured to work in accordance with the query layer 308. In an embodiment, the visualization unit 212b is configured to work in accordance with the visualization layer 310.

In operation, the data fusion unit 210 may be configured to extract the customer care data from the database server 102, via the communication network 106. In an alternate embodiment, the data fusion layer 304 may receive the customer care data directly from the one or more data sources. The data fusion unit 210 is configured to utilize the one or more semantic web protocols to perform the data fusion of the plurality of parameters. In an embodiment, the data fusion unit 210 utilizes the RDF data model to perform the data fusion of the plurality of parameters. The data fusion unit 210 is configured to determine dependencies within the plurality of parameters. In order to determine the dependencies between the plurality of parameters, the data fusion unit 210 may be configured to create the plurality of data structures from the plurality of parameters. In an embodiment, the one or more semantic web protocols are utilized by the data fusion unit 210 to create the plurality of data structures. The data fusion unit 210 is configured to fuse the plurality of data structures to generate the semantic graph representation.

In an embodiment, a query is received via the querying unit 212a to extract the subset of data structures from the plurality of data structures. The plurality of data structures correspond to the plurality of semantic graph representations of the plurality of parameters. In response to the query received from the querying unit 212a, the analytics unit 208 may be configured to utilize the subset of data structures to determine the one or more observations. In an embodiment, the graph processing unit 208a may be configured to apply the one or more graph processing techniques on the subset of data structures to determine the one or more observations. In an alternate embodiment, the machine learning unit 208b may be configured to apply the one or more machine learning techniques on the subset of data structures to determine the one or more observations.

In response to the application of the one or more graph processing techniques and/or the one or more machine learning techniques, the visualization unit 212b may be configured to generate the one or more visual representations of the one or more observations. In an embodiment, the one or more visual representations are transmitted to the user-computing device 108. In an embodiment, the one or more visual representations may be displayed on the display device of the application server 104. In an embodiment, the intuitive visualization user interface is provided to the user to view the one or more observations pertaining to the subset of the data structures on a display device. In an alternate embodiment, an interactive visualization is provided to the user to view the one or more observations pertaining to the subset of the data structures on the display device. In an embodiment, a notification comprising the one or more observations pertaining to the query may be transmitted to the user-computing device associated with a customer care agent who will receive the communication from the customer via a communication network. In an embodiment, the notification may be transmitted before receiving the communication from the customer.

FIG. 4 illustrates an exemplary scenario 400 of implementation of the protocol architecture 300 in a customer care domain, in accordance with at least one embodiment. FIG. 4 is explained in conjunction with elements from FIG. 1, FIG. 2, and FIG. 3.

With reference to FIG. 4, at block 404, the data source layer 302 may retrieve a plurality of parameters associated with a plurality of customers from a plurality of data sources 402. In an embodiment, the plurality of data sources 402 may be associated with the customer care domain. Examples of the plurality of parameters associated with a plurality of customers in the customer care domain include customer id, customer name, customer location, customer email, product name, service name, problem reported, and the like. At block 406, the data fusion layer 304 in conjunction with the data fusion unit 210 may create the plurality of data structures using one or more semantic web protocols. Based on the plurality of data structures, the data fusion unit 210 may generate the semantic graph representation 406a. The semantic graph representation 406a represents a single data structure generated by fusing the plurality of data structures.

At block 408, the analytics unit 208 may receive a query from the user computing device 108. For example, the query may be representative of determining a number of customers associated with a product name. In an embodiment, the query may be input using a Simple Protocol and RDF Query language (SPARQL). SPARQL is a SQL-like language that utilizes the RDF triplets for retrieving the one or more observations associated with the plurality of parameters from the semantic graph representation 406a. Further, in order to determine the one or more observations associated with the query using the analytics unit 208, the analytics unit 208 utilizes input from the domain ontology 412, the domain specific language 414, and the domain rules 416.

In an embodiment, the domain ontology 412, the domain specific language 414, and the domain rules 416 are stored in the memory 204 of the application server 104. For example, a concept “Top Product Name” may be defined by the processor 202 and may be stored in the memory 204. The concept “Top Product Name” may be defined such that it captures the product names that are used by the plurality of customers. Further a threshold may be defined to identify the product names. Such a threshold may correspond to the domain rules 416. For example, a product name such as “Nokia Lumia 920” may be considered as under the domain ontology “Top Product Name” if the number of customers that use “Nokia Lumia 920” is greater than ten million customers. The domain rules 416 and the domain ontology may be utilized by the domain specific language layer 312 to generate the query received from the user computing device 108.

Based on the query received from the user computing device 108, the analytics layer 306 may either utilize one or more machine learning techniques and/or graph based analytics techniques to determine the one or more observations associated with the query. For example, in order to determine the number of customers associated with a product name, a graph based analytics technique may be used. Based on the domain ontology 412 and the domain rules 416, the graph based analytics technique may determine the number of customers associated with a product name. The number of customers associated with a product name may correspond to the one or more observations.

At block 418, the visualization unit 212b may receive the number of customers associated with a product name (one or more observations). Further, the visualization unit 212b may be configured to create a visual representation, such as a bar chart 418a of the number of customers associated with a product name. In an embodiment, the visual representation may be transmitted to the user computing device 108 that was used to query the application server 104. In an embodiment, the notification comprising the one or more observations pertaining to the query may be transmitted to the user-computing device associated with a customer care agent who will receive the communication from the customer via a communication network. In an embodiment, the notification may be transmitted before receiving the communication from the customer.

A person skilled in the art will understand that exemplary scenario of implementation of the protocol architecture 300 in the customer care domain has been described herein for illustrative purposes and should not be considered to limit the scope of the disclosure in any manner. The protocol architecture 300 may be implemented in other domains such as healthcare domain, financial domain, educational domain and the like.

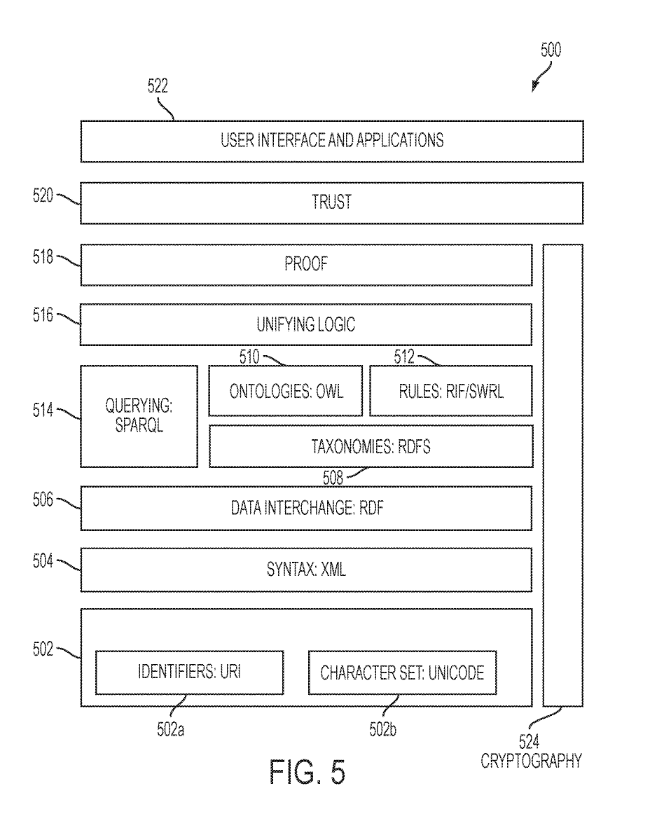

FIG. 5 illustrates a layered block diagram illustrating a semantic web architecture, in accordance with at least one embodiment. FIG. 5 is explained in conjunction with elements from FIG. 1, FIG. 2, and FIG. 3.

The semantic web architecture creates a universal medium to convert the plurality of parameters into the plurality of data structures. The first layer 502 comprises of identifiers 502a and a character set 502b. The identifiers 502a are represented by Uniform Resource Identifier (URI) and the character set is represented by UNICODE. URI is a string of a standardized form that allows the processor 202 to uniquely identify resources such as documents, images, videos and the like. In an embodiment, the plurality of data sources may correspond to the plurality of parameters in the customer care data. A subset of URI is Uniform Resource Locator (URL), which contains access mechanism and a network location of the resource. Another subset of URI is URN that allows to identify the resource without determining the location and the access mechanism. The usage of URI is important for a distributed internet system as it provides identification of all resources. An international variant to URI is Internationalized Resource Identifier (IRI) that allows usage of UNICODE characters in the identifier and a mapping to URI is defined. UNICODE is a standard of encoding international character sets and it allows that all human languages can be used on the web using one standardized form.

The second layer 504 represents the syntax utilized by the semantic web architecture. eXtensible Markup Language (XML) layer with XML namespace and XML schema definitions makes sure that there is a common syntax used in the semantic web. XML is a general-purpose markup language for documents containing structured information. A XML document contains elements that can be nested and that may have attributes and content associated with the plurality of parameters. The XML namespaces allow to specify different markup vocabularies in one XML document. The XML schema is utilized by the processor 202 for expressing schema of a set of XML documents.

The third layer 506 represents a data interchange format utilized by the semantic web architecture. In an embodiment, the data representation format for semantic web is Resource Description Framework (RDF). The RDF is a framework for representing the plurality of parameters in the semantic graph representation. The RDF is based on triplets formed based on the attributes associated with a parameter. For each parameter, the attributes associated are a subject, a predicate, and an object. The data fusion unit 210 may be configured to create the RDF triplets associated with each parameter. The set of RDF triplets represents the semantic graph representation of the plurality parameters. Each RDF triplet denoted as <s,p,o> (subject, predicate, object) represents an edge in the graph and the plurality of parameters represent the plurality of nodes. In an embodiment, the RDF serves as a description of the data structure formed by the RDF triplets.

The fourth layer 508 represents taxonomies defined by domain experts. The taxonomies define vocabulary of terms used for detailed description of the plurality of data structures. For standardized description of taxonomies and other ontological constructs, the data fusion unit 210 may be configured to create a RDF Schema (RDFS). The data fusion unit 210 utilizes the RDFS to describe the taxonomies and create a plurality of ontologies. The fifth layer 510 is configured to create detailed ontologies by utilizing the Web Ontology Language (OWL). The plurality of ontologies capture expert's domain knowledge through concepts, properties, and known relationships between the plurality of data structures. The OWL is a language derived from description logics based on the RDFS. In an embodiment, the OWL is syntactically embedded into the RDF such that the OWL provides additional standardized vocabulary associated with the plurality of parameters. In an embodiment, the OWL is based on a description logic. In an embodiment, the OWL utilizes set theoretic operations to define classes. Further, OWL supports class/property restrictions or domain area facts about properties associated with the plurality of parameters.

In an embodiment, the data fusion unit 210 defines semantics for the RDFS and the OWL. The data fusion unit 210 may utilize the semantics for reasoning within ontologies and the plurality of parameters in the customer care data. In an alternate embodiment, the analytics layer 306 may utilize the RDFS and the OWL to determine the one or more observations associated with the plurality of data structures based on the query. In an embodiment, the RDFS enables definition of semantics using notions such as a class/subclass with a domain/range restrictions on a property associated with a data structure from the plurality of data structures.

The sixth layer 512 represents a plurality of rule languages utilized by the data fusion unit 210 while performing the data fusion. In an embodiment, the plurality of rule languages include, but are not limited to, RIF and SWRL. The seventh layer 514 is configured for querying the plurality of data structures as well as the RDFS and the OWL ontologies. In an embodiment, the query languages utilized by the seventh layer 514 include, but not limited to, a Simple Protocol and RDF Query language (SPARQL). SPARQL is a SQL-like language that utilizes the RDF triplets for retrieving the one or more observations associated with the plurality of data structures. In an embodiment, SPARQL is utilized to query the RDFS and the OWL.

A person skilled in the art will appreciate that SPARQL is not only the query language, but SPARQL is a protocol for accessing RDF data. A person with ordinary skills in the art would understand that the scope of the disclosure is not limited to the functionalities of the one or more layers of the semantic web architecture as discussed herein. The one or more functionalities of the one or more layers of the semantic web architecture described herein are only for illustrative purposes and should not be considered to limit the scope of the disclosure in any manner.

The eighth layer represents the unifying logic 516 that may be utilized to create new facts based on valid inferences over existing facts. In an embodiment, the unifying logic 516 may correspond to a first order logic that may provide mathematical basis to create the new facts. The ninth layer represents the proof 518 that correspond to theoretic and material basis for deriving the proofs of inferences determined via the unifying logic 516. Further, the ninth layer may keep a track of a sequence of inference rules that may be employed to derive the one or more facts. The tenth layer represents the trust 520 that may be configured to quantify levels of trust that an entity has on a service or person and inversely. In an embodiment, one or more mathematical methods may be utilized to identify a trust relation between two entities. The eleventh layer represents the user interface and applications 522. In an embodiment, the user interface and applications 522 may correspond to semantic-enabled user interfaces and applications. Such user interfaces and applications may be fine-tuned for an application domain by appropriately configuring the layers described in the semantic web architecture. In an embodiment, cryptography layer 524 may be utilized encrypt data in all the layers mentioned herein.

Thus, the semantic web architecture as discussed above is utilized by the data fusion unit 210 for performing the data fusion on the plurality of parameters. The data fusion is performed on the data fusion layer 304 in accordance with the semantic web architecture as discussed above. The data fusion unit 210 may be configured to convert the plurality of parameters into the plurality of data structures, also annotated as the semantic graph representation, based on the semantic web architecture.

A person skilled in the art will understand that only semantic web architectures need not necessarily be used for performing data fusion. In an embodiment, an architecture similar to the semantic web architecture is utilized for performing data fusion. The semantic web architecture described herein is for illustrative purposes and should not be considered to limit the scope of the disclosure in any manner.

FIG. 6 is a flowchart 600 illustrating a method to determine problems faced by a customer associated with a product, in accordance with at least one embodiment. The flowchart 600 is described in conjunction with FIG. 1, FIG. 2, and FIG. 3.

In an exemplary scenario, the protocol architecture 300 as explained in FIG. 3 may be utilized by the application server 104 in the domain of customer care to determine problems faced by a customer associated with a product. In accordance with the protocol architecture 300, the data source layer 302 may be configured to receive the plurality of parameters in the customer care data from the plurality of data sources. In an embodiment, the plurality of parameters may correspond to data associated with the plurality of domains. For example, the parameters associated with the customer care domain may comprise customer id, customer name, customer location, customer email, product name, service name, problem reported, and the like.

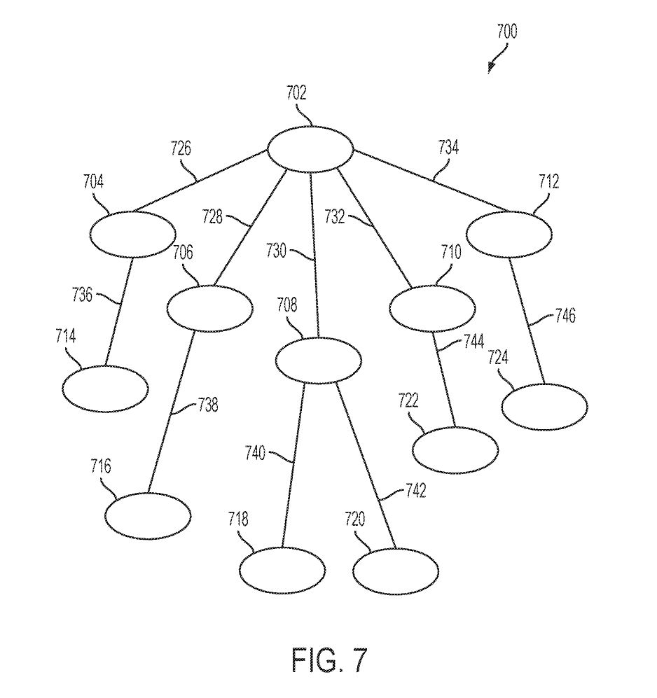

Further, based on the received plurality of parameters, the data fusion unit 210 may be configured to perform the data fusion of the plurality of parameters in accordance with the data fusion layer 304. The data fusion unit 210 may further be configured to create the plurality of data structures from the plurality of parameters based on the RDF model that may utilize the one or more semantic web protocols to perform the data fusion. The data fusion unit 210 may further be configured to perform the data fusion in order to determine the dependencies within each of the plurality of parameters. For example, a semantic graph is generated by the data fusion unit 210 as shown in FIG. 7 later captures the dependencies within each of the plurality of parameters.

In an embodiment, the query layer 308 may be configured to receive a query to predict one or more problems faced by the customer associated with the product, before receiving a communication from the customer. In an embodiment, the processor 202 may be configured to determine how many number of times each problem is reported by the customer. In an alternate embodiment, the query layer 308 may be configured to predict one or more problems, which may have been reported by the customer greater than a pre-defined number of times. In an embodiment, the one or more observations may correspond to the one or more problems occurring more than the pre-defined number of times.

In an embodiment, the graph based analytics layer 306a in conjunction with the graph processing unit 208a may be configured to assign a weight to each of the plurality of problems. In an embodiment, the graph processing unit 208a may assign equal weights to each of the plurality of problems. In an embodiment, when the customer reports a problem, the graph processing unit 208a may update the weight assigned to each problem based on the problem reported by the customer. In an embodiment, the graph processing unit 208a may increase the weight of the problem reported by the customer based on a pre-defined constant value. However, the one or more problems faced by the customer within a time period may change. Thus, in order to capture the one or more problems faced by the customer within a time period, the graph processing unit 208a may decrease the weight of the remaining problems by the pre-defined constant value. Thus, by associating the weight with each of the problems, the graph processing unit 208a may predict the one or more problems faced by a customer associated with the product, before receiving the communication from the customer.

In an exemplary scenario, let the weight associated with each problem be denoted by wᵢ. Let the problem faced by the customer be represented by j. Let ε be the pre-defined constant.

The method starts at step 602. At step 604, the graph processing unit 208a assigns a weight equal to one to the plurality of problems. At step 606, a problem j faced by the customer is received. At step 608, the graph processing unit 208a increases the weight of problem j by a factor of (1+ε). Thus, the weight of the problem j is wj=wj (1+ε). At step 610, the graph processing unit 208a decreases the weight of the remaining problems by a factor of (1−ε). At step 612, the graph processing unit 208a checks whether the value of wj is above a pre-defined threshold. If the value of wj is greater than the pre-defined threshold, then method proceeds to step 614 else the method proceeds to step 622.

At step 614, the graph processing unit 208a is configured to predict, before receiving the communication from the customer, that j is one of the one or more problems faced by the customer. At step 616, the graph processing unit 208a checks whether any other problem is reported by the customer. If a new problem is reported by the customer, then control passes to step 606, else control passes to step 618. At step 618, a notification comprising the one or more observations pertaining to the query may be transmitted to the user-computing device associated with a customer care agent who will receive the communication from the customer via a communication network. In an embodiment, the notification may be transmitted before receiving the communication from the customer. At step 620, the one or more problems predicted before receiving the communication from the customer are displayed on a display screen. Control passes to end step 622.

A person skilled in the art will understand that the example of determining one or more problems faced by a customer associated with a product, before receiving a communication from the customer has been provided for illustrative purposes and should not be construed to limit the scope of the disclosure.

FIG. 7 is a data structure 700, illustrating relationship between the plurality of parameters, in accordance with at least one embodiment. FIG. 7 is explained in conjunction with elements from FIG. 1, FIG. 2, and FIG. 3.

In an embodiment, the data source layer 302 may receive the plurality of parameters in the customer care data from diverse plurality of data sources. For example, the information regarding a battery problem reported by a “customer id 12345” is obtained from email. Further, the “customer id 12345” owns a product “iPhone” is obtained via a social media update posted by the “customer id 12345”. The name, address, email, location are also obtained from a social media profile. Thus, the data fusion layer 304 in conjunction with the data fusion unit 210 may utilize the plurality of parameters and creates the plurality of data structures. The data fusion layer 304 in conjunction with the data fusion unit 210 may further be configured to combine the plurality of data structures in one data structure that captures the plurality of parameters received from the plurality of data sources.

FIG. 7 illustrates the pictorial view of the data fusion performed on the plurality of parameters in the application area of customer care based on the one or more semantic web protocols. As shown in FIG. 7, each parameter may be represented as a node of the graph. Further, each edge of the graph represents a RDF triplet. Each RDF triplet that corresponds to an edge of the graph represents a fact between the parameters connected by the edge.

The node 702 in the graph 700 represents a “customer id 12345”. The node 704 in the graph 700 represents a “battery life”. The edge 726 in the graph 700 represents the relation between the node 702 and 704. Thus, the RDF triplet is represented as (customer id 12345, reported problem, battery life). The RDF triplet formed by the nodes 702, 704, and the edge 726 connecting the nodes 702, and 704 represents a fact the “customer id 12345” reported a problem that is related to “battery life”.

The node 706 in the graph 700 represents an “iPhone”. The edge 728 in the graph 70 represents the relation between the node 702 and 706. Thus, the RDF triplet is represented as (customer id 12345, product, iPhone). The RDF triplet formed by the nodes 702, 706, and the edge 728 connecting the nodes 702, and 706 represents a fact the “customer id 12345” owns a product “iPhone”.

The node 708 in the graph 700 represents “x@y.com”. The edge 730 in the graph 700 represents the relation between the node 702 and 708. Thus, the RDF triplet is represented as (customer id 12345, email, x@y.com). The RDF triplet formed by the nodes 702, 708, and the edge 730 connecting the nodes 702, and 708 represents a fact that the “customer id 12345” has email “x@y.com”.

The node 710 in the graph 700 represents “USA”. The edge 732 in the graph 700 represents the relation between the node 702 and 710. Thus, the RDF triplet is represented as (customer id 12345, location, USA). The RDF triplet formed by the nodes 702, 710, and the edge 732 connecting the nodes 702, and 710 represents a fact that the location of the “customer id 12345” is “USA”.

The node 712 in the graph 700 represents “John Smith”. The edge 734 in the graph 700 represents the relation between the node 702 and 712. Thus, the RDF triplet is represented as (customer id 12345, name, John Smith). The RDF triplet formed by the nodes 702, 712, and the edge 734 connecting the nodes 702, and 712 represents a fact that the name of the “customer id 12345” is “John Smith”.

The node 714 in the graph 700 represents “Hardware”. The edge 736 in the graph 700 represents the relation between the node 704 and 714. Thus, the RDF triplet is represented as (battery life, issue type, hardware). The RDF triplet formed by the nodes 704, 714, and the edge 736 connecting the nodes 704, and 714 represents a fact that the issue type of the “battery life” is “hardware”. In an exemplary scenario, the nodes 702, 704, 714 and the edges 726, and 736 represents a fact that the customer id 12345 reported a problem with regard to the battery and the “issue type” is “hardware”.

The node 716 in the graph 700 represents “Dec. 14, 2013”. The edge 738 in the graph 700 represents the relation between the node 706 and 716. Thus, the RDF triplet is represented as (iPhone, new release, Dec. 14, 2013). The RDF triplet formed by the nodes 706, 716, and the edge 738 connecting the nodes 706, and 716 represents a fact that the new release date for “i Phone” is “Dec. 14, 2013”.

The node 718 in the graph 700 represents “Gold”. The edge 740 in the graph 700 represents the relation between the node 708 and 718. Thus, the RDF triplet is represented as (x@y.com, status, gold). The RDF triplet formed by the nodes 708, 718 and the edge 740 connecting the nodes 708, and 718 represents a fact that the status of the email id of the “customer id 12345” is “gold”.

The node 720 in the graph 700 represents “24”. The edge 742 in the graph 700 represents the relation between the node 708 and 720. Thus, the RDF triplet is represented as (x@y.com, age, 24). The RDF triplet formed by the nodes 708, 720 and the edge 742 connecting the nodes 708, and 720 represents a fact that the age of the customer with email x@y.com and “customer id 12345” is “24”.

The node 722 in the graph 700 represents “New York”. The edge 744 in the graph 700 represents the relation between the node 710 and 722. Thus, the RDF triplet is represented as (USA, city, New York). The RDF triplet formed by the nodes 710, 722 and the edge 744 connecting the nodes 710, and 722 represents a fact that the location of the “customer id 12345” is “USA” and the city is “New York”.

The node 724 in the graph 700 represents “Flat 2, Elita, CA”. The edge 746 in the graph 700 represents the relation between the node 724 and 712. Thus, the RDF triplet is represented as (John Smith, address, Flat 2, Elita, Calif.). The RDF triplet formed by the nodes 724, 712 and the edge 746 connecting the nodes 724, and 712 represents a fact that the address of “John Smith” is “Flat 2, Elita, Calif.”.

Thus, the graph processing unit 208a may utilize the semantic graph representation of the plurality of parameters to determine the implicit dependencies between the plurality of parameters. Based on the semantic graph representation as shown in FIG. 7, the graph processing unit 208a may be configured to derive the one or more observations by applying the one or more graph analytics techniques on the semantic graph representation.

A person skilled in the art will understand that the pictorial view of the data fusion performed on the plurality of parameters using one or more semantic web protocols as described herein is for illustrative purposes and should not be considered to limit the scope of the disclosure in any manner.

FIG. 8 is a flowchart 800 illustrating a method for analyzing the customer care data, in accordance with at least one embodiment. FIG. 8 is explained in conjunction with elements from FIG. 1, FIG. 2, and FIG. 3.

The method starts at step 802. At step 804, the data source layer 302 in conjunction with the data fusion unit 210 may be configured to receive the plurality of parameters in the customer care data from the plurality of data sources. At step 806, the data fusion layer 304 in conjunction with the data fusion unit 210 may be configured to perform data fusion of the plurality of parameters using the one or more semantic web protocols based on the semantic web architecture. At step 808, the data fusion layer 304 in conjunction with the data fusion unit 210 may be configured to create the plurality of data structures based on the one or more semantic web protocols. In an embodiment, the plurality of data structures corresponds to the semantic graph representation generated by the data fusion unit 210. At step 810, the query layer 308 in conjunction with the querying unit 212a may be configured to receive the query from the user-computing device 108. Based on the received query, at step 812, the query layer 308 in conjunction with the querying unit 212a may be configured to extract the subset of data structures from the plurality of data structures. At step 814, the analytics layer 306 in conjunction with the graph processing unit 208a and/or machine learning unit 208b may be configured to implement one or more graph analytics techniques and/or machine learning techniques on the subset of data structures. In an embodiment, the graph processing unit 208a may be configured to implement the one or more graph analytics techniques such as clustering, segmentation, temporal analysis, and the one or more machine learning techniques. At step 816, the visualization layer 310 in conjunction with the visualization unit 212b may be configured to generate a visualization indicative of the one or more observations derived based on the one or more graph analytics techniques and/or the one or more machine learning techniques. At step 818, the visualization layer 310 in conjunction with the visualization unit 212b may be configured to display the one or more observations on the display screen. In an embodiment, the visualization layer 310 may be configured in such a manner that the user may view the one or more observations in multiple layouts based on an input form the user. In an embodiment, the user may also be able to export the one or more observations in a portable format, such as pdf. In an alternate embodiment, the user may utilize the user-computing device 108 to perform the progressive data exploration based on the one or more queries. Control passes to end step 820.

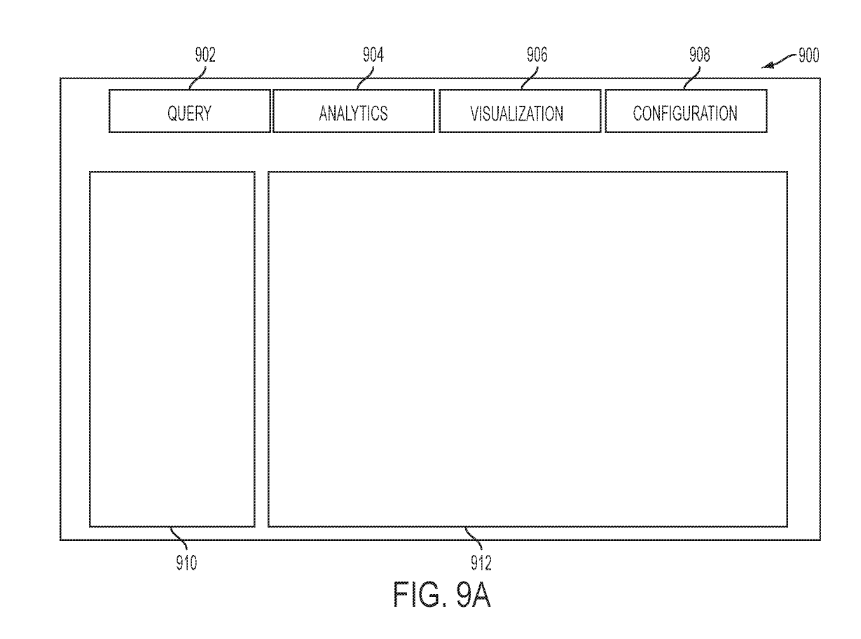

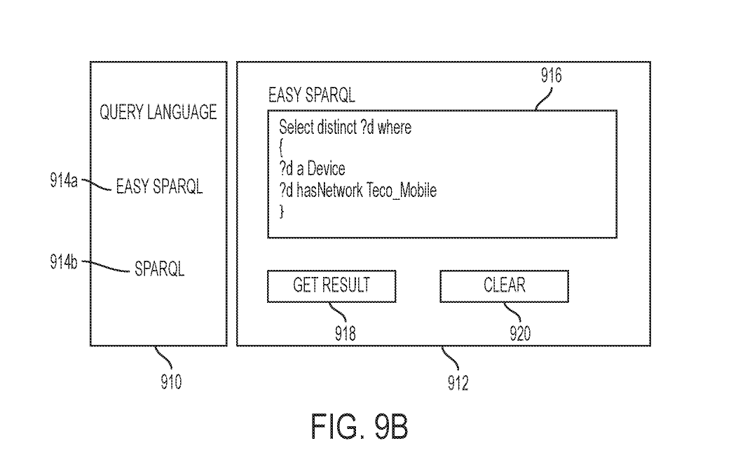

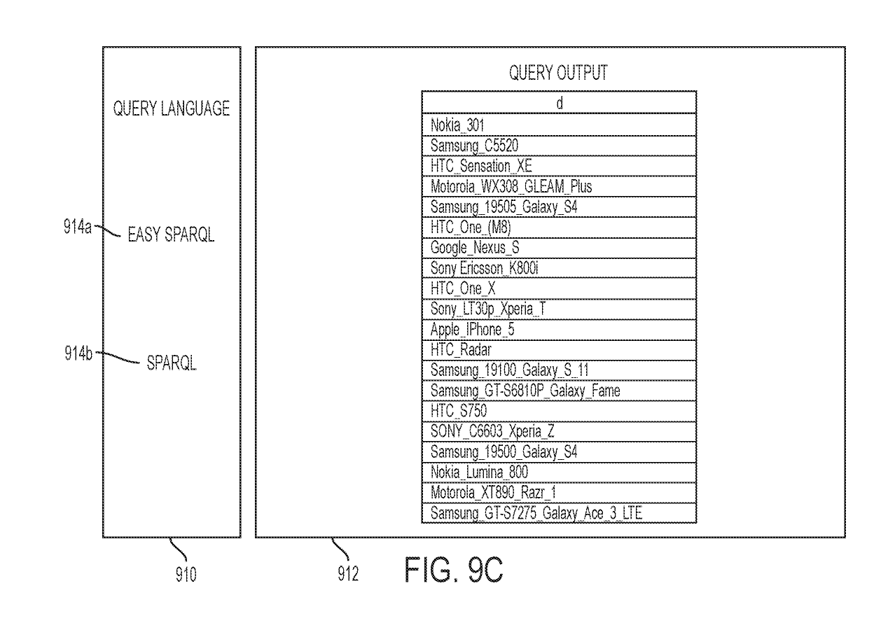

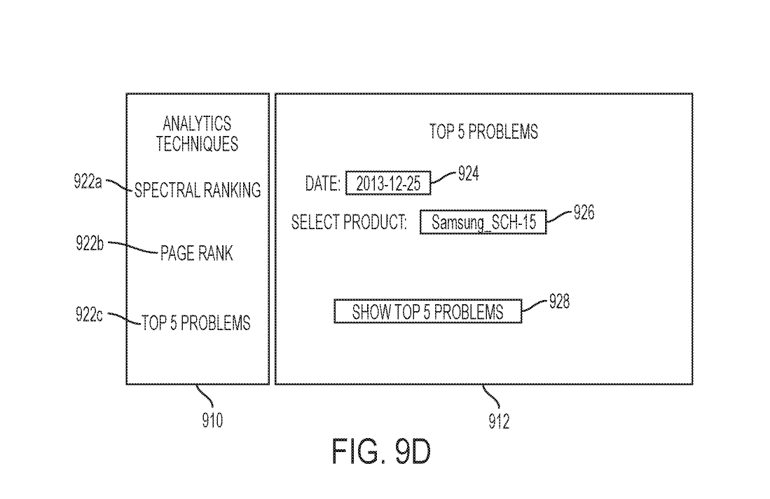

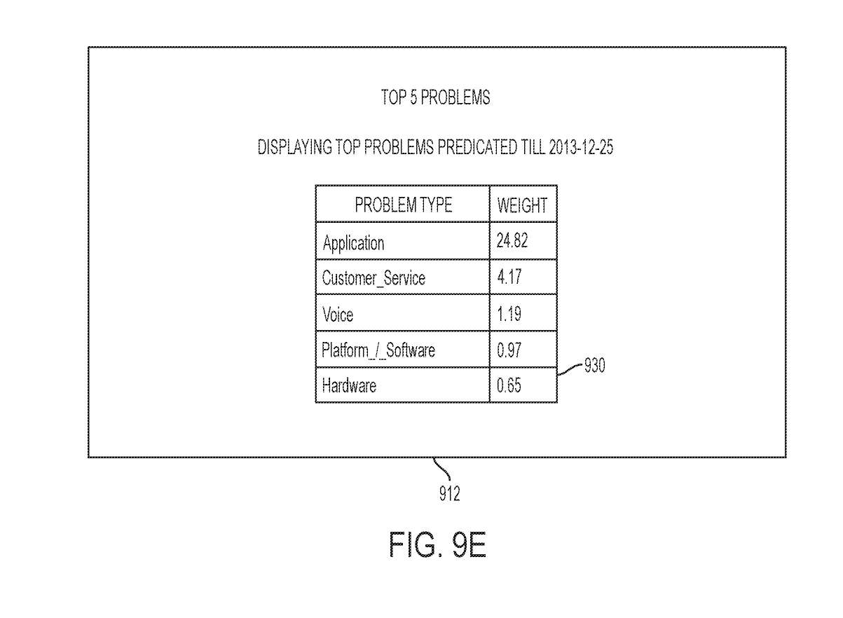

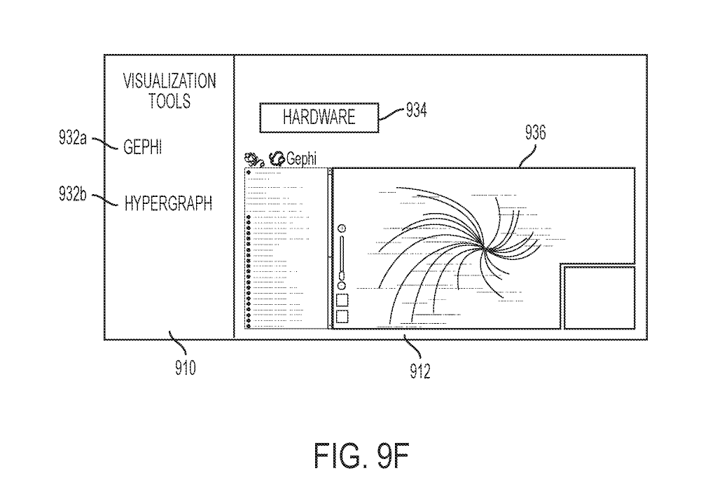

FIGS. 9A, 9B, 9C, 9D, 9E, and 9F illustrate example user interface 900 presented on the user-computing device 108, in accordance with at least one embodiment. The user interface 900 is described in conjunction with FIG. 1, FIG. 2, and FIG. 3.

With reference to FIG. 9A, the user interface 900 comprises of four tabs. The four tabs include a query tab 902, an analytics tab 904, a visualization tab 906, and a configuration tab 908. Further, the user interface 900 comprises of a first display area 910 and a second display area 912. In an embodiment, content displayed in the first display area 910 and the second display area 912 may change based on the tab that may be selected from the four tabs.

With reference to FIG. 9B, the first display area 910 and the second display area 912 display content associated with the query tab 902 when an input operation, such as a click operation is performed on the query tab 902. When the input operation is performed on the query tab 902, in the first display area 910 one or more query languages, such as EasySPARQL 914a, SPARQL 914b are displayed that may be utilized by the query layer 308. The second display area 912 displays an input text box 916 that may be utilized by the user to input the query. For example, a query as depicted in the input text box 916 may be input. Further, a first command button 918 is shown that may be configured to display the output associated with the input query in the input text box 916 in the second display area 912. Further, a second command button 920 is shown that may be configured to clear the text in the input text box 916.

With reference to FIG. 9C, in response to the input operation on the first command button 918, an output is displayed in the second display area 912 corresponding to the input query. For example, as shown in FIG. 9C, a table that corresponds to the output of the query shown in FIG. 9B is displayed in the second display area 912.

With reference to FIG. 9D, when the user performs a mouse click event on the analytics tab 904, the processor 202 is configured to display a plurality of analytics techniques such as, “spectral analysis” 922a, “PageRank” 922b, and “top-5 problems” 922c in the first display area 910.

The graph processing unit 208a is configured to utilize the plurality of analytics techniques to determine one or more observations related to the customer care data based on the query input in the input text box 916. When the plurality of analytics techniques are displayed the first display area 910, a user input is received from the user via a user-computing device 108 to select at least one of the analytics techniques for processing the query entered by the user in the input box.

For example, the user selects the spectral analysis technique for processing the query. Based on the selected analytics technique from the first display area 910, the visualization unit 212b is configured to display an output of the selected analysis technique in the second display area 912. The output corresponds to the one or more observations associated with the customer care data. For example, the second display area 912 displays the spectral analytics for the query received in the input box. The spectral analysis displays a list of mobile phones and a Euclidian distance associated with each of the mobile phone. The spectral analysis illustrates that the “LG_VS410_Optimus_Zone” mobile phone is facing the highest number of network issues. In an embodiment, the user interface 900 may provide another command button (not shown) that enables the user to export the data shown in the second display area 912. In an embodiment, the visualization unit 212b is configured to export the data displayed in the second display area 912 in the form of portable document format.

In another exemplary scenario, when the user performs the input operation on “top-5 problems” 922c in the first display area 910, as shown in FIG. 9D, the second display area 912 displays a input box 924, a drop down list 926, and a third command button 928. The user inputs a data corresponding to which customer care data may be analyzed. Further, the user selects a product from the drop down list 926 for which the user wants to know about the top-5 problems faced by the customers. For example, as shown in the FIG. 9D, the user selects the product “Samsung_SCH-15”. The user then performs the input operation on the third command button 928. The third command button 928 may be configured to display a table 930 that illustrates the top-5 problems, in the second display area 912, faced by the customers using the selected product as shown in FIG. 9E. In an embodiment, a weight associated with each of the top-5 problems may also be displayed in the table 930.

Further, when the user performs the mouse click event on the visualization tab 906, the visualization unit 212b is configured to display a visualization of the one or more observations. With reference to FIG. 9F, the first display area 910 provides one or more third party visualization tools, such as Gephi 932a, HyperGraph 932b that the visualization unit 212b may utilize to create the visualization. Further, an input box 934 is provided in the second display area 912. The input box 934 may be utilized by the user to search the customer care data. For example, the user enters the search term “hardware”, in response to the input in the input box 934, a visualization 936 may be displayed in the second display area 912.

In an embodiment, the visualization unit 212b is configured to export the visualization displayed in the second display area 912 in the form of portable document format. In an alternate embodiment, the second display area 912 is configured to display a plurality of visualizations. In an embodiment, the user may input a plurality of queries and the second display area 912 may display the plurality of visualizations associated with the plurality of queries.

The user interface 900 further displays the configuration tab 908. When the user performs the mouse click event on the configuration tab 908, the user may be enabled to modify one or more settings associated with the plurality of analytics techniques. In an embodiment, the user may adjust a setting associated with precision. Further, the configuration tab 908 may enable the user to change a color scheme of the user interface. In an embodiment, the user may select the types of visualizations that the visualization unit 212b utilizes to display the visualization on the second display area 912.

The person skilled in the art will understand that the selection of the tab need not necessarily be via the mouse click event. An event configured to select the appropriate tab may also be used to select the tab. The selection of the tab using the mouse click event is described herein for illustrative purposes and should not be considered to limit the scope of the disclosure in any manner.

In another implementation of the disclosed method and the system, the architecture described in FIG. 3 is utilized for graphical analysis of customer care data related to the education sector. For example, the architecture is utilized to determine one or more observations associated with the education sector. In an embodiment, the customer care data associated with the education sector is received from the plurality of data sources. In an embodiment, the parameters associated with the education sector comprise student name, educational institute, student age, student address, educational institute address, course name, faculty qualification, cut off percentage, location of educational institute, campus placement percentage, passing percentage, and the like. The data source layer 302 is configured to receive the plurality of parameters from the plurality of data sources and transmit them to the data fusion layer 304. Based on the parameters received from the data source layer 302, the data fusion layer 304 utilizes the one or more semantic web protocols to create the plurality of data structures. In an embodiment, the data structure corresponds to the graphical representation of the parameters in the customer care data.

In an embodiment, a student who is planning to seek admission in an educational institute utilizes the disclosed method and the system. The student inputs a query such as, “display educational institutes with location X, cut off percentage 72%, and order the educational institutes in descending order of the campus placement percentage”. Based on the query received via the query layer 308, the analytics layer 306 applies one or more graph analytics techniques and machine learning techniques on the plurality of data structures to display the one or more observations associated with the query. Further, the visualization layer 310 is configured to display a visualization of the one or more observations associated with the query. In an embodiment, the visualizations may include graphs such as, bar graph, scatter chart, bubble chart, pie chart, and the like. For example, the bar graph is displayed to the user that indicates all educational institutes with location X, with cut off percentage 72%. Further, the bar chart is created in such a manner that the bars in the chart are ordered in a descending manner. Thus, the student may utilize the displayed bar chart to decide which institute he/she can apply based on the visualization of the one or more observations associated with the query.

The person skilled in the art will understand that the user interface 900 are described herein for illustrative purposes and should not be considered to limit the scope of the disclosure in any manner.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer to derive one or more observations between a plurality of parameters in a customer care data. The at least one code section in an application server 104 causes the machine and/or computer comprising one or more processors to perform the steps, which comprises receiving customer care data from a plurality of data sources. Further, the one or more processors transform the customer care data to create a plurality of data structures utilizing one or more semantic protocols. In an embodiment, the plurality of data structures represents a relationship between one or more parameters in the customer care data. The one or more processors extract a subset of data structures from the plurality of data structures based on a query received via a query interface. Further, the one or more processors apply one or more graph analytics techniques on the subset of data structures to determine one or more observations associated with the subset of data structures. Based on the one or more graph analytics techniques, the one or more processors display the one or more observations on a display screen.

Various embodiments of the disclosure encompass numerous advantages including methods and systems for deriving one or more observations between a plurality of parameters in a customer care data. As discussed above, the disclosed methods and systems provides an improved method for data fusion of the plurality of parameters in the customer care data received from the plurality of data sources. The data fusion is performed by creating the plurality of data structures using one or more semantic web protocols. Further, the disclosed methods and systems enables the user to perform data mining on the customer care data in an improved manner and helps to derive one or more observations associated with the plurality of parameters.

A person skilled in the art will understand that the above listed advantages of the disclosed methods and systems is for illustrative purposes and should be considered to limit the scope of the claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for deriving one or more observations between a plurality of parameters associated with a plurality of customers in a customer care data, the method comprising:
receiving, by one or more processors, the customer care data from a plurality of data sources, wherein the customer care data received from the plurality of data sources comprises a plurality of problems faced by a customer from the plurality of customers while operating a product, wherein the plurality of problems corresponds to the plurality of parameters;
transforming, by the one or more processors, the customer care data to create a plurality of data structures utilizing one or more semantic web protocols, wherein the plurality of data structures represents a relationship between the plurality of parameters associated with the plurality of customers in the customer care data;
extracting, by the one or more processors, a subset of data structures from the plurality of data structures based on a query received via a query interface, wherein the query comprises predicting one or more problems from the plurality of problems, wherein the one or more problems comprises the plurality of problems occurring more than a pre-defined number of times, wherein the one or more problems is predicted before receiving a communication from the customer;
applying, by the one or more processors, one or more graph analytics techniques on the subset of data structures to determine one or more observations associated with the subset of data structures, wherein the one or more observations corresponds to the one or more problems occurring more than the pre-defined number of times; and
transmitting, by the one or more processors, a notification comprising the one or more observations pertaining to the query, to a user-computing device associated with a customer care agent who will receive the communication from the customer via a communication network, wherein the notification is transmitted before receiving the communication from the customer.

2. The method of claim 1, wherein the plurality of data structures are created based on one or more machine learning techniques, a domain ontology, an ontology vocabulary, and a plurality of domain specific rules.

3. The method of claim 1, wherein the one or more semantic web protocols comprise a Resource Descriptive Framework language, Web Ontology Language, Ontology Inference Layer, DARPA Agent Markup Language, Web Services Modeling Language, and Web Services Semantics.

4. The method of claim 1, wherein the query interface supports at least one of a query language including Simple Protocol and RDF Query Language (SPARQL), SeRQL, RDQL, R-Device, and Versa.

5. The method of claim 1, wherein the plurality of data structures correspond to a plurality of graphs, wherein each graph from the plurality of graphs is formed by a set of nodes and a set of edges, wherein the set of nodes correspond to the plurality of parameters and the set of edges correspond to the relationship between the plurality of parameters.

6. The method of claim 1, wherein the relationship between the plurality of parameters is represented by three attributes, including a subject, a predicate and an object, associated with each parameter.

7. The method of claim 1, wherein the one or more graph analytics techniques comprise graph clustering, graph-based entity ranking, linear regression, graph segmenting, temporal analysis, spectral analysis, and one or more machine learning techniques.

8. The method of claim 1, wherein the one or more graph analytics techniques assign a weight to each of the plurality of problems faced by the customer from the plurality of customers while operating the product.

9. The method of claim 1, wherein the one or more graph analytics techniques comprise dynamically assigning an updated weight to the plurality of problems based on a pre-defined constant value and a time period.

10. The method of claim 9, further comprising displaying the plurality of problems faced by the customer, on the display screen based on the updated weight.

11. The method of claim 1, wherein the one or more observations are displayed on a display screen of the user-computing device.

12. An application server to derive one or more observations between a plurality of parameters associated with a plurality of customers in a customer care data, the application server comprising:
one or more processors in the application server, wherein the application server is connected to a user computing device associated with a customer care agent via a communication network, the one or more processors being configured to:
receive the customer care data from a plurality of data sources;
transform the customer care data to create a plurality of data structures utilizing one or more semantic web protocols, wherein the plurality of data structures represents a relationship between the plurality of parameters in the customer care data;
extract a subset of data structures from the plurality of data structures based on a query received via a query interface;
apply one or more graph analytics techniques on the subset of data structures to determine one or more observations associated with the subset of data structures; and
display the one or more observations, on a display screen, pertaining to the query based on the one or more graph analytics techniques.

13. The application server of claim 12, wherein the one or more processors are further configured to create the plurality of data structures based on one or more machine learning techniques, a domain ontology, an ontology vocabulary, and a plurality of domain specific rules.

14. The application server of claim 12, wherein the one or more semantic web protocols comprise a Resource Descriptive Framework language, Web Ontology Language, Ontology Inference Layer, DARPA Agent Markup Language, Web Services Modeling Language, and Web Services Semantics.

15. The application server of claim 12, wherein the query interface supports at least one of a query language including Simple Protocol and RDF Query Language, SeRQL, RDQL, R-Device, and Versa.

16. The application server of claim 12, wherein the plurality of data structures correspond to a plurality of graphs, wherein each graph from the plurality of graphs is formed by a set of nodes and a set of edges, wherein the set of nodes correspond to the plurality of parameters and the set of edges correspond to the relationship between the plurality of parameters.

17. The application server of claim 12, wherein the one or more graph analytics techniques assign a weight to each of the plurality of parameters.

18. The application server of claim 17, wherein one or more graph analytics techniques dynamically update the weight assigned to each parameter of the plurality of parameters based on a pre-defined constant value and a time period.

19. A non-transitory computer-readable storage medium having stored thereon, a set of computer-executable instructions for causing a computer comprising one or more processors to perform steps comprising:
receiving, by one or more processors, customer care data from a plurality of data sources, wherein the customer care data received from the plurality of data sources comprises a plurality of problems faced by a customer from a plurality of customers while operating a product, wherein the plurality of problems corresponds to a plurality of parameters;
transforming, by the one or more processors, the customer care data to create a plurality of data structures utilizing one or more semantic web protocols, wherein the plurality of data structures represents a relationship between the plurality of parameters associated with the plurality of customers in the customer care data;
extracting, by the one or more processors, a subset of data structures from the plurality of data structures based on a query received via a query interface, wherein the query comprises predicting one or more problems from the plurality of problems, wherein the one or more problems comprises the plurality of problems occurring more than a pre-defined number of times, wherein the one or more problems is predicted before receiving a communication from the customer;
applying, by the one or more processors, one or more graph analytics techniques on the subset of data structures to determine one or more observations associated with the subset of data structures, wherein the one or more observations corresponds to the one or more problems occurring more than the pre-defined number of times; and
transmitting, by the one or more processors, a notification comprising the one or more observations pertaining to the query, to a user-computing device associated with a customer care agent who will receive the communication from the customer via a communication network, wherein the notification is transmitted before receiving the communication from the customer.
